(19) United States
(12) Patent Application Publication
(10) Pub. No.: US 2013/0237415 A1
(43) Pub. Date: Sep. 12, 2013

(54) SAFENER COMPOSITIONS AND METHODS FOR REDUCING MYCOTOXINS

(71) Applicants: Patrick John Doyle, Greensboro, NC (US); Marian Ladislav Stypa, Greensboro, NC (US)

(72) Inventors: Patrick John Doyle, Greensboro, NC (US); Marian Ladislav Stypa, Greensboro, NC (US)

(73) Assignee: SYNGENTA CROP PROTECTION LLC, Greensboro, NC (US)

(21) Appl. No.: 13/809,801

(22) PCT Filed: Jul. 13, 2011
(86) PCT No.: PCT/US11/43789

§ 371 Date: Apr. 3, 2013

Related U.S. Application Data
(60) Provisional application No. 61/363,881, filed on Jul. 13, 2010.

(51) Int. Cl. A01N 47/38; A01N 47/28; A01N 41/06; A01N 43/653; A01N 43/56; A01N 43/80; A01N 47/30; A01N 43/42

(52) U.S. Cl. CPC A01N 47/38; A01N 47/30; A01N 47/28; A01N 43/42; A01N 43/653; A01N 43/56; A01N 43/80; A01N 41/06
USPC 504/105; 504/111; 504/106; 504/112

(57) ABSTRACT

Methods, compositions, and uses of herbicide safeners alone, and in combination with fungicides, to reduce mycotoxin accumulation, fungal infection and related disease in agricultural crops, plants and harvested plant material are disclosed.

### TECHNICAL FIELD

The invention relates to the technical field of crop protection compositions and methods, in particular to compositions and methods for reducing contamination of mycotoxins and/or secondary fungal metabolites on plants or harvested plant materials, including treatment with one or more herbicide safeners.

### BACKGROUND

Fungi are serious pathogens that adversely impact crop yield and harvest quality in a variety of economically important agricultural crops. Many fungal metabolites accumulate as toxic byproducts of fungal infection within agricultural crops and often pose a major problem for the production agriculture throughout the world. Mycotoxins are toxic secondary metabolites produced by organisms of the fungus kingdom. The term ‘mycotoxin’ also generally refers to toxic compounds produced by fungi that readily colonize crops. In this regard, mycotoxins are often characterized by the ability to harm crops and cause health problems for people and animals.

Prior efforts at mycotoxin control include fungicide-only based treatment methods. WO2009/068195 describes methods for reducing mycotoxin contamination of maize plants, particularly genetically modified maize, by treating the plant or plant material with one or more fungicides. WO2007/003320 describes methods of reducing mycotoxin contamination of a plant or harvested plant material by treating plant propagation material with one or more fungicides. WO2007/009969 describes combinations of metconazole and epoxiconazole for reducing contamination of cereals with mycotoxin.

Such efforts have sometimes yielded inconclusive results. Mycotoxin contamination levels and levels of fungal colonization for diseases such as Fusarium Head Blight of cereals or Fusarium Ear Rot of maize, are influenced by a variety of factors. Among these are environmental conditions, agricultural conditions, level of host crop resistance to primary fungal infection, colonization of the crops by different fungal species, innoculum levels of various fungal pests, timing of infection, and mechanism of fungal infection of crops. For example, Fusarium species that produce Fumonosin mycotoxins infect maize by wound inoculation of plant tissues. The wound source may be handling-related, such as by harvesting, sorting, storing, and shipping, or can be caused by insects. Wounds from insects such as the European corn borer, Southwestern corn borer, and the corn earworm, are frequently thought to cause disease in maize. Other fungal species, for example Fusarium graminearum and Aspergillus flavus, are known to infect maize through the silk channel. Similarly, a wide range of factors can influence the extent and severity of Fusarium graminearum, Fusarium culmorum, etc. infection of cereal crops such as wheat, barley, oats, etc. Existing mycotoxin treatments, for example, fungicides treatment alone, may not be effective at combating mycotoxin production and disease development across these variabilities.

Accordingly, there is a need to increase available methods and compositions in preventing, treating, and reducing accumulation of mycotoxin contamination and secondary fungal metabolites and related fungal infection and disease in crops, plants and harvested materials, either adjunct to or in place of existing fungicidal practices.

### SUMMARY

The invention provides compositions and methods for reducing the accumulation of mycotoxin and secondary fungal metabolite contamination in agricultural crops, plants, and harvested plant material. This aspect includes one or more herbicide safeners, optionally with one or more additional active ingredients, including a fungicide. Methods include applying one or more herbicide safeners, optionally with one or more additional active ingredients, including a fungicide, to an agricultural crop, plant, or harvested plant material, optionally in the absence of a co-applied herbicide.

The invention further provides compositions and methods for reducing infection of mycotoxin-producing pathogens and related disease in agricultural crops, plants, and harvested plant material. This aspect includes one or more herbicide safeners, optionally with one or more additional active ingredients, including a fungicide, optionally in the absence of a herbicide.

The invention further provides an agricultural crop or plant, treated with one or more herbicide safeners, optionally with one or more additional active ingredients, including a fungicide, optionally in the absence of a co-applied herbicide.

The invention further provides a system and methods for determining the need of an agricultural crops or plants for applications of one or more of herbicide safeners, optionally with one or more additional active ingredients, to treat or prevent accumulation of mycotoxin or secondary fungal metabolite contamination. The invention further includes a system and methods for determining the efficacy of an agent or agents to reduce such contamination.

The invention further provides a system and methods for determining the need of an agricultural crops or plants for application of one or more herbicide safeners, optionally with one or more additional active ingredients, to treat or prevent infection of mycotoxin-producing pathogens, including Fusarium, in agricultural crops, plants, for harvested plant material. The invention further includes a system and methods for determining the efficacy of an agent or agents to reduce such infection.

The invention further provides a system and methods for determining the need of an agricultural crop for applications of a one or more herbicide safeners, optionally with one or more additional active ingredients, in response to disease, including Fusarium Head Blight, related to a mycotoxin-producing pathogen infection in agricultural crops, plants, and harvested plant material. The invention further includes a system and methods for determining the efficacy of an agent or agents to reduce such disease.

In accordance with other aspects and embodiments, compositions and methods are provided for enhancing yield and/or vigor of agricultural crops. This aspect includes one or more herbicide safeners, optionally with one or more additional active ingredients, including a fungicide, optionally in the absence of a herbicide.

The invention further provides compositions and methods for controlling fungal pathogenesis in agricultural crops, plants, and harvested plant material. This aspect includes one or more herbicide safeners, optionally with one or more additional active ingredients, including a fungicide, optionally in the absence of a herbicide.

The above was intended to summarize certain exemplary aspects and embodiments of the invention. Mixtures, methods, compositions, additives, treated plants, etc. will be set forth in more detail, in the detailed description below. It will be apparent, however, that the detailed description is not intended to limit the present invention, the scope of which should be properly determined by the appended claims.

### DETAILED DESCRIPTION OF EXEMPLARY EMBODIMENTS

Mycotoxins include aflatoxin, beauvericin, citrinin, cytochalasins, enniatin, ergot alkaloids, fumonisin, fusaproliferin, fusaric acids, fusarins, gliotoxin, moniliformin, ochratoxin, patulin, sterigmatocystin, trichothecene, zeranol, and zearalenone, among others.

Aflatoxins are mycotoxins produced by many species of the Aspergillus, including A. flavus and A. parasiticus. These are known to affect several crops including oilseeds, spices, tree nuts, and cereals, in particular corn and wheat, before and after harvest of the crop as well as during storage. Aflatoxins are considered both toxic and carcinogenic. After entering the body, aflatoxins are believed to be metabolized by the liver into reactive epoxides. High-level exposure in the liver can produce an acute hepatic necrosis, resulting later in cirrhosis, and possibly carcinoma. More than twenty different toxin subtypes have been identified, including aflatoxin B₁, B₂, G₁, G₂, M₁ and M₂.

Beauvericin is a mycotoxin produced by the fungus Beauveria bassiana as well as several other fungi, including many Fusarium species which can also produce fumonisin and trichothecene mycotoxins. Beauvericin-producing fungal species can infect a broad range of crop plants including wheat, barley, and corn. Beauvericin has been classified as a cation chelating agent, ionophore, and general antibiotic. Beauvericin is a potent inhibitor of acyl-coenzyme A/cholesterol acyl-transferase activity in microsomes of rat and mouse livers and human cell lines.

Citrinin is a mycotoxin produced by Penicillium species such as P. citrinum and P. camemberti. Citrinin is also produced by various Aspergillus species including: A. niveus, A. oryzae, A. terreus, and various Monascus species including: M. ruber, M. purpureus. Citrinin has mainly been found in rice, wheat, flour, barley, maize, rye, oats, peanuts and fruit and may co-occur in cereals with ochratoxin A. There is evidence of citrinin surviving unchanged into cereal food products. Exposure to citrinin in the diet brings short and long term effects on health such as intoxication to acute exposure and carcinogenic results from chronic exposure.

Cytochalasins are fungal metabolites that can affect crops ranging from potato to millet. Cytochalasins A and B are metabolites of Helminthosporium dematioideum; Cytochalasins C and D are metabolites of Metarrhizium anisopliae; Cytochalasin E is a metabolite of Rosellinia necatrix; Cytochalasin F is a metabolite of Helminthosporium dematioideum; Cytochalasins H and J are metabolites of Phomopsis paspali found on Paspalum scrobiculatum Linn., a millet consumed in India. Exposure to cytochalasins can result in altered cellular morphology, inhibition of cellular processes, and eventually programmed cell death, or apoptosis, in both plant and mammalian cells. Adverse effects can be attributed to toxin subtype. Cytochalasin A and B can inhibit the transport of monosaccharides across cell membranes, cytochalasin H adversely affects plant growth, cytochalasin D inhibits protein synthesis, cytochalasin E can prevents blood vessel development. The remaining cytochalasins (C, F, G, and J) are also generally regarded as toxic.

Enniatins are mycotoxins produced mainly by Fusarium species such as F. oxysporum, F. sambucinum, F. acuminatum, F. avenaceum, etc. These are known to affect wheat and other small grain cereals, and potatoes before and after harvest. Enniatins have been classified with beauvericin and other cyclichexadepsipeptides as cation chelating agents, ionophores, and general antibiotics. Enniatins can cause adverse effects associated with inhibition of acyl-coenzyme A/cholesterol acyltransferase in animals and humans. In plants, enniatins play a role in Fusarium pathogenesis as they can cause effects ranging from wilting of shoots, inhibition of growth of seedlings, and dry rot of potatoes. Many enniatin toxin subtypes have been classified, including enniatin A, A₁, A₂, B, B₁, B₄, C, D, E, and F.

Ergot alkaloids are metabolites produced by many fungi within the genus Claviceps upon infection of healthy plants. Agricultural crops most commonly affected include cereals such as wheat, barley, rye and oats. Dietary exposure to ergot alkaloids causes a wide range of biological activities including effects on circulation and neurotransmission within humans and animals. Collectively, these effects are referred to as ‘ergotism’ based on severe pathological syndromes affecting humans or animals that have ingested ergot alkaloid-containing plant material, such as ergot-contaminated grains. Of the many ergot alkaloids found within infected grain, ergotamine and ergoline are regarded as most common.

Fumonisins are produced by Fusarium species found on various agricultural crops, particularly maize, in the field and during storage. Fusarium kernel rot is a fumonisin related disease of corn, believed to be caused by F. moiliforme, F. proliferatum, and F. verticillioides, among others. Certain fumonisins, for example fumonisin B₁, are believed to increase apoptosis in liver and kidney tissues. At least ten forms of fumonisins have been identified, including fumonisin B₁, B₂, B₃, B₄, A₁, A₂, A₃, P₁, P₂, and P₃. Fumonisin B₁ is the most prevalent in contaminated corn and is believed to be the most toxic.

Fusaproliferin is a secondary fungal metabolite produced by Fusarium species that infect various agricultural crops, particularly maize, in the field and during storage. The natural occurrence of fusaproliferin has been reported feed samples of maize and other feed samples infected with Fusarium proliferatum and F. subglutinans in Europe and the United States. Limited studies have been conducted to elucidate the fusaproliferin toxicology, however, studies to date suggest that this mycotoxin can function as a potent toxin to human lymphocytes, as well as a teratogen within poutry feeding studies and a strong inhibitor of plant cell growth.

Fusaric Acid and related analogues (e.g., Fusaric acid diacid; 10,11-Dihydroxy Fusaric acid; and Fusaric acid 7-methyl ester) are produced by a wide range of Fusarium species including those that also concurrently produce Fumonisins (e.g., F. verticillioides), Trichothecenes (e.g., F. crookwellense). Fusaric acid-producing species can infect a broad range of crop plants, thus fusaric acid could occur, and accumulate to significant levels within a wide variety of foods and feeds. Fusaric acid is believed to have low to moderate toxicity in a wide range of animal systems, but has been shown to have a wide range of effects on mammalian neurological, cardiovascular, and immune systems.

Fusarins are mycotoxins produced by a range of Fusarium species including those that also produce mycotoxins such as Fumonisin (e.g., F. verticillioides) and Trichothecene (e.g., F. graminearum, F. sporotrichoides, etc.). Fusarin-producing species can infect a broad range of crop plants, thus fusarins could occur in a wide variety of foods and feeds. Of those monitored, fusarin contamination of maize is most commonly reported in geographies ranging from USA, to EU, to Africa. A range of toxic effects have been reported for animal exposure to the five structures of Fusarin that have been identified: Fusarin A, C, D, E, and F.

Gliotoxin is a sulfur-containing mycotoxin produced by several species of fungi, such as Aspergillus, and also by species of Trichoderma, and Penicillium. Gilotoxin is known to affect various crops used for animal feed, particularly silage maize. Gliotoxin is immunotoxic, meaning that it is toxic to the immune system based on immunosuppressive properties and effects related to programmed cell death (apoptosis) in certain types of cells of the immune system. For this reason, exposure to gilotoxins is regarded as a cause of immune deficiencies in higher order mammals.

Moniliformin production is widely distributed among many Fusarium species including those that produce Fumonisin and Trichothecene mycotoxins. Moniliformin-producing species can infect a wide variety of crop plants, thus, moniliformin potentially could occur in a range of foods and feeds. The natural occurrence of moniliformin in China within crops such as maize, oats, rye, triticale, and wheat is of particular interest because of the suggested association of this mycotoxin with the high rate of Keshan heart disease that is endemic to certain regions. As a contaminant of feed, moniliformin is regarded as very toxic toward fowl, particularly chickens. Toxicity of moniliformin to plants has been documented, however the specific interaction to Fusarium pathogenicity is not currently known.

Ochratoxins are mycotoxins produced by certain Aspergillus and Penicilium species, such as A. ochraceus, A. carbonarius or P. viridicatum. Ochratoxins include ochratoxin A, ochratoxin B, and ochratoxin C. Ochratoxin A is the most prevalent and relevant fungal toxin of this group as it is known to occur in commodities such as cereals, coffee, dried nuts, and red wine. Ochratoxin A is considered a human carcinogen and is of special interest as it can bioaccumulate from contaminated feed into the meat of animals. Dietary exposure to ochratoxins can result in acute toxic effects on the kidney as well as nephrotoxic, teratogeic, and immunosuppressive effects on humans and animals.

Patulin is a mycotoxin produced by a variety of fungi, particularly Aspergillus and Penicillium species. Patulin is commonly found as a post harvest toxin within apples, pears and grapes. Recent reports indicate that patulin can be found in some vegetables. Although patulin is not generally regarded as a potent toxin, it has been shown to have genotoxic properties in animal studies based on reported damage to DNA and chromosomes. Several countries have instituted patulin restrictions at part per billion (ppb) levels on fruit-based products and within processed food, particularly for infants and young children.

Sterigmatocystin is a toxic metabolite that is structurally similar to the Aflatoxins. Sterigmatocystin is mainly produced by Aspergillus fungi (A. nidulans, A. versicolor, etc.). It has been reported in field crops such as small grain cereals (e.g., wheat), maize, pecan nuts, and coffee. The toxic effects of sterigmatocystin are much the same as those of aflatoxin B1. It is thus considered as a potent carcinogen, mutagen and teratogen.

Trichothecenes are a very large family of sesquiterpene epoxide mycotoxins produced by species in the genera Acremonium (Cephalosporium), Cylindrocarpon, Dendrodochium, Myrothecium, Trichoderma, Trichothecium, and most numerously in Fusarium. These mycotoxins are often associated with disease epidemics within cereal field crops such as maize, wheat, barley, rye, rice, sorghum and oats. Trichothecene toxicity within human, animal and plants is believed to relate to inhibition of eukaryotic protein synthesis. A multitude of trichothecene mycotoxins have been identified, including but, not limited to: isotrichodermol, isotrichodermin, calonectrin, 3-deacetylcalonectrin, 15-deacetylcalonectrin, 3,15-dideacetylcalonectrin, 15-acetoxyscirpenol, 4,15-diacetoxyscirpenol, 3,4,15-triacetoxyscirpenol, neosolaniol, 3-acetylneosolaniol, nivalenol, 4-acetylnivalenol, 3,15-diacetylnivalenol, 4,15-diacetylnivalenol, deoxynivalenol (DON), 3-acetyldeoxynivalenol, 15-acetyldeoxynivalenol, 3,15-diacetyldeoxynivalenol, 3-acetyl-T-2 toxin, 4,7,15-acetylnivalenol T-2 Toxin, HT2 Toxin, scirpentriol, Diacetoxyscirpenol (DAS) and acyl derivatives thereof. Fusarium Head Blight is a global disease of small grain cereals that is believed to be most commonly associated with DON, produced by Fusarium species such as F. graninearum and F. culmorum. Food- and feed-borne exposure to trichothecenes has been reported throughout the globe. For this reason, trichothecene levels are carefully regulated within food and feed shipments based on strict advisory levels.

Zeranol is a mycotoxin commonly found in Fusarium infected field crops such as wheat, barley, oats and corn. Zeranol is potent estrogen agonist that is generally considered to be 3-4 times more potent than structurally-similar Zearalenone mycotoxins. In fact, zeranol has been approved for use as a growth promoter in commercial livestock, including beef cattle, in the United States. However, its application currently is not approved for use in the European Union or Canada. Additionally, zeranol has been classified as a prohibited anabolic agent by some regulatory bodies.

Zearalenones are produced by a wide range of Fusarium species, including those that can also produce trichothecene mycotoxins (e.g., F. graminearum, F. culmorum, F. crookwellense, etc.). Like most other mycotoxins, zearalenones are heat-stable and are found in a number of cereal crops including maize, barley, oats, rice, and sorghum and processed foods derived from these commodities. The toxic effect of zearalenones is primarily attributed to infertility, abortion and feeding problems, particularly in swine. At least eight forms of zearalenones have been identified, including zearalenone, α- and β-zearalenol, α- and β-zearalanol, 11-hydroxyzearalenone, 14-hydroxyzearalenone, 4-acetylzearalenone, 5-formylzearalenone. All of these mycotoxins demonstrate a wide range of estrogenic activity.

Other secondary fungal metabolites are also known. Cyclopiazonic acid is a fungal secondary metabolite considered to exhibit toxicity in high concentrations. Its toxic properties are believed to be related to inhibition of Ca²⁺-ATPase in intracellular Ca²⁺ storage sites. Cyclopiazonic acid is produced by several species of the Aspergillus and Penicillium, including P. cyclopium P. cyclopium, P. griseofulvum, P. camembertii, A. flavus, and A. versicolor.

Historically, mycotoxins and compounds such as cyclopiazonic acid have been referred to as “secondary metabolites” because their biosynthesis is not required for the primary functions of fungal growth and reproduction.

Acute and chronic mycotoxicoses in animals and in humans is often associated with consumption of Fusarium-contaminated cereals such as, wheat, rye, barley, oats, rice and maize. Although adverse effects are most commonly associated with consumption of trichothecene mycotoxins, dietary exposure to very common mycotoxins such as aflatoxins, fumonisins, ochratoxins, and zearalenones, as well as less common mycotoxins, can have significant short- and long-term adverse impacts.

Experiments with chemically pure trichothecenes at low dosage levels have reproduced many of the features observed in moldy-grain toxicoses in animals, including anaemia and immunosuppression, hemorrage, emesis and feed refusal. Historical and epidemiological data from human populations indicate an association between certain disease epidemics and consumption of grain infected with Fusarium species that produce trichothecenes. A fatal disease known as alimentary toxic aleukia has occurred in Russia and has been associated with consumption of over-wintered grains contaminated with Fusarium species that produce the trichothecene T-2 toxin. In Japan, outbreaks of a similar disease called akakabi-byo or red mold has been associated with grain infected with Fusarium species that produce the trichothecene DON. Similar epidemiological accounts have been reported for human and animal exposure to mycotoxins such as aflatoxins, fumonisins, ochratoxins, and zearalenones, as well as some of the less commonly reported mycotoxins.

Mycotoxin-producing Fusarium spp. are known to be destructive pathogens to a wide range of plant species. Acute phytotoxicity of plant tissue in response to a mycotoxin exposure has also been observed. This suggests that mycotoxins play a role in the pathogenesis of Fusarium on plants, particularly in wheat and maize. Accordingly, such mycotoxins are believed to function as a mechanism of virulence within plant pathogenesis and disease development. As such, treatments to reduce mycotoxin accumulation within infected crops may also prevent or significantly limit the impact of disease development within affected crops.

For example, the production of deoxynivalenol (DON) and its acetylated precursors 3-acetyl-DON and 15-acetyl-DON by F. graminearum, and various other Fusarium species, have been shown as virulence factors for “Fusarium Head Blight” (also known as “Head Scab”, or “Tombstone”) of small grain cereals and Fusarium Ear Rot of maize. Conversely, techniques taken to reduce disease levels within affected crops may have the additional benefit of reducing mycotoxin contamination on the host crop and particularly where the host plant is a cereal that is susceptible to Fusarium infection.

Plant includes any and all plant or plants, plant material, and plant populations such as desirable and undesired wild plants, cultivars (including naturally occurring cultivars) and plant varieties (whether or not protectable by plant variety or plant breeder's rights). Cultivars and plant varieties can be plants obtained by conventional breeding or breeding methods assisted or supplemented by one or more biotechnological methods, including the use of double haploids, protoplast fusion, random and directed mutagenesis, molecular or genetic markers, bioengineering, and other genetic engineering methods including transgenic plants.

Plant material includes above-ground and below-ground parts and organs of plants such as shoots, leaves, flowers, blossoms and roots, including, for example, needles, stems, branches, blossoms, fruiting bodies, fruits and seed as well as roots, corms and rhizomes. Plant material also includes crops and vegetative generative propagating material, for example cuttings, corms, rhizomes, runners, fruits, grains, seeds, pods, fruiting bodies, tubers and seedlings, and seeds.

Harvest includes the process of removing plant or plant material from the environment supporting growth of the plant. Post harvest includes the period of time starting with the harvest of plant or plant material, optimally, through to a time period just prior to immediately before consumption. Harvested plant material, post harvested plant material, and the like, may include, but is not limited to, cells, fruits, leaves, flowers, and stems.

Crops, plants, and harvested plant material include various useful crops including cereals, leguminous plants, oil plants, cucumber plants, pome fruits, bacciferous plants, vegetables, and coffee. In various embodiments: cereals include grain, wheat, barley, rye, oats, maize (corn), rice, sorghum and related crops; leguminous plants include beans, lentils, peas, soybeans, peanuts, treenuts and related crops; oil plants include cotton, oilseed rape, mustard, sunflowers and related plants; cucumber plants include marrows, cucumbers, melons and related plants; pome fruits include apples, and pears; bacciferous plants include grapes, blueberries, and cranberries; and vegetables include spinach, lettuce, asparagus, cabbages, carrots, eggplants, olives, onions, pepper, tomatoes, potatoes, paprika and related plants used for spices. Preferably the plant is maize or wheat.

In various embodiments, the plant is one producing a product for human consumption, such as small grain cereals, maize, oats, and peanuts. In a preferred embodiment, the crop is selected from maize and wheat.

Herbicide safeners include any agriculturally acceptable foliar or soil-applied herbicide safener, including 4-(dichloroacetyl)-3,4-dihydro-3-methyl-2H-1,4-benzoxazine (benoxacor); [(5-chloro-8-quinolinyl)oxy]acetic acid (cloquintocet); 1-methylhexyl[(5-chloro-8-quinolinyl)oxy]acetate (cloquintocet-methyl); N-[(2-chlorophenyl)methyl]-N′-(1-methyl-1-phenylethyl)urea (cumyluron); N-[[4-[(cyclopropylamino)carbonyl]phenyl]sulfonyl]-2-methoxybenzamide (cyprosulfamide); N-(4-methylphenyl)-N′-(1-methyl-1-phenylethyl)urea (daimuron); 2,2-dichloro-N,N-di-2-propenylacetamide (dichlormid); 1-(dichloroacetyl)hexahydro-3,3,8a-trimethylpyrrolo[1,2-a]pyrimidin-6(2H)-one (dicyclonon); O,O-diethyl O-phenyl phosphorothioate (dietholate); S-(1-methyl-1-phenylethyl) 1-piperidinecarbothioate (dimepiperate); 1-(2,4-dichlorophenyl)-5-(trichloromethyl)-1H-1,2,4-triazole-3-carboxylic acid (fenchlorazole); ethyl-1-(2,4-dichlorophenyl)-5-(trichloromethyl)-1H-1,2,4-triazole-3-carboxylate (fenchlorazole-ethyl); 4,6-dichloro-2-phenylpyrimidine (fenclorim); phenylmethyl 2-chloro-4-(trifluoromethyl)-5-thiazolecarboxylate (flurazole); 3-(dichloroacetyl)-5-(2-furanyl)-2,2-dimethyloxazolidine (furilazole); 4,5-dihydro-5,5-diphenyl-3-isoxazolecarboxylic acid (isoxadifen); ethyl 4,5-dihydro-5,5-diphenyl-3-isoxazolecarboxylate (isoxadifen-ethyl); 1-(2,4-dichlorophenyl)-4,5-dihydro-5-methyl-1H-pyrazole-3,5-dicarboxylic acid (mefenpyr); diethyl 1-(2,4-dichlorophenyl)-4,5-dihydro-5-methyl-1H-pyrazole-3,5-dicarboxylate (mefenpyr-diethyl); 4-chlorophenyl methylcarbamate (mephenate); 1H,3H-naphtho[1,8-cd]pyran-1,3-dione (naphthalic anhydride); 4-(dichloroacetyl)-1-oxa-4-azaspiro[4.5]decane (AD-67 MON 4660); (RS)-1-dichloroacetyl-3,3,8a-trimethylperhydropyrrolo[1,2-a]pyrimidin-6-one (dicyclonone); and N-(2-methoxybenzoyl)-4-[(methylaminocarbonyl)amino]benzenesulfonamide.

In various embodiments, the herbicide safener is selected from cloquintocet-methyl, cyprosulfamide, cumyluron, daimuron, dimepiperate, fenchlorazole-ethyl, isoxadifen-ethyl, mefenpyr-diethyl, and N-(2-methoxybenzoyl)-4-[(methylaminocarbonyl)amino]benzenesulfonamide.

In further various embodiments, the herbicide safener is selected from cloquintocet-methyl and N-(2-methoxybenzoyl)-4-[(methylaminocarbonyl)amino]benzenesulfonamide.

In various embodiments, a herbicide safener is used in combination with, or mixed with, at least one other active ingredient, preferably a fungicide.

Fungicide includes phenylpyrrole fungicides, benzimidazole fungicides, dithiocarbamate fungicides, imidazole fungicides, methoxyacrylate fungicides, methoxycarbamate fungicides, oximino acetate fungicides, oximino acetamide fungicides, oxazolidine-dione fungicides, dihydrodioxazine fungicides, imidazolinone fungicides, aliphatic nitrogen (guanidine) fungicides, anilide fungicides, dicarboximide fungicides, thiophanate fungicides, aromatic hydrocarbon fungicides, hydroxyanilide fungicides, benzamide fungicides, carbamate fungicides, phosphonate fungicides, carboxylic acid fungicides, quinoline fungicides, thiazolecarboxamide fungicides, benzamidoxime fungicides, quinazolinone fungicides, benzophenone fungicides, acylpicolide fungicides, anilinopyrimidine fungicides, cyanoimidazole fungicides, benzotriazine fungicides, benzenesulfonamide fungicides pyridazinone fungicides, thiophenecarboxamide fungicides, pyrimidinamide fungicides and carboxylic acid amide fungicides, thiocarbamate fungicides, benzo-thiadiazole fungicides, triazole fungicides and amide fungicides.

In various embodiments, phenylypyrrole fungicides include fludioxonil and fenpiclonil; benzimidazole fungicides include carbendazim, benomyl, fuberidazole, and thiabendazole; dithiocarbamate fungicides include ferbam, mancozeb, maneb, metiram, propineb, thiram, zineb, and ziram; imidazole fungicides include imazalil, oxpoconazole, pefurazoate, prochloraz, and triflumizole; methoxyacrylate fungicides include azoxystrobin, enestrobin, and picoxystrobin; methoxycarbamate fungicides pyraclostrobin; oximino acetate fungicides include kresoxim-methyl and trifloxystrobin; oximino acetamide fungicides include dimoxystrobin, metominostrobin, and orysastrobin; oxazolidine-dione fungicides include famoxadone; dihydrodioxazine fungicides include fluoxastrobin; imidazolinone fungicides include fenamidone; aliphatic nitrogen (guanidine) fungicides include dodine, guazatine, and iminoctadine; anilide fungicides include sedaxane, fluxapyroxad, isotianil, and penflufen; dicarboximide fungicides include chlozolinate, iprodione, procymidone, and vinclozolin; thiophanate fungicides include thiophanate and thiophanate-methyl; aromatic hydrocarbon fungicides include chloroneb, dicloran, quintozene (PCNB), tecnazene (TCNB), and tolclofos-methyl; hydroxyanilide fungicides include fenhexamid; benzamide fungicides include zoxamide; carbamate fungicides include iodocarb, propamocarb, and prothiocarb; phosphonate fungicides include fosetyl-Al, phosphorous acid, carboxylic acid fungicides include oxolinic acid; quinoline fungicides include quinoxyfen; thiazolecarboxamide fungicides include ethaboxam; benzamidoxime fungicides include cyflufenamid; quinazolinone fungicides include proquinazid; benzophenone fungicides include metrafenone; acylpicolide fungicides include fluopicolide; anilinopyrimidine fungicides include cyprodinil, mepanipyrim, and pyrimethanil; cyanoimidazole fungicides include cyazofamid; benzotriazine fungicides include triazoxide; benzenesulfonamide fungicides include flusulfamide; pyridazinone fungicides include diclomezine; thiophenecarboxamide fungicides include silthiofam; pyrimidinamide fungicides include diflumetorim; carboxylic acid amide fungicides include dimethomorph, flumorph, benthiavalicarb, iprovalicarb, and mandipropamid; thiocarbamate fungicides include methasulfocarb; benzo-thiadiazole fungicides include acibenzolar-5-methyl; triazole fungicides include thiabendazole, ipconazole, prothioconazole, triticonzole, triflumizole, metconazole, tebuconazole, tetraconazole, epoxiconzole, azaconazole, bitertanol, bromuconazole, cyproconazole, diniconazole, simenconazole, fenbuconazole, flusilazole, flutriafol, hexaconazole, imibenconazole, myclobutanil, penconazole, propiconazole, simeconazole, triadimefon, triadimenol, and fluquinconazole; and amide fungicides include benodanil, boscalid, fluopyram, bixafen, penthiopyrad, carboxin, fenfuram, flutolanil, furametpyr, mepronil, oxycarboxin, penthiopyrad, thifluzamide, 3-difluoromethyl-1-methyl-1H-pyrazole-4-carboxylic acid(9-dichloromethylene-1,2,3,4-tetrahydro-1,4-methano-naphthalen-5-yl)amide, 3-difluoromethyl-1-methyl-1H-pyrazole-4-carboxylic acid [2-(2,4-dichlorophenyl)-2-methoxy-1-methyl-ethyl]-amide, and 3-difluoromethyl-1-methyl-1H-pyrazole-4-carboxylic acid methoxy-[1-methyl-2-(2,4,6-trichlorophenyl)-ethyl]-amide, and salts thereof.

In further embodiments, a fungicide includes at least one or more of fludioxonil, thiabendazole, triticonzole, ipconazole, prothioconazole, prochloraz, carbendazim, thiram, oxpoconazole, triflumizole, pefurazoate, metconazole, fluoxastrobin, azoxystrobin, pyraclostrobin, trifloxystrobin, picoxystrobin, guazatine, tebuconazole, tetraconazole, imazalil, epoxiconzole, carboxin, fluquinconazole, and 3-difluoromethyl-1-methyl-1H-pyrazole-4-carboxylic acid methoxy-[1-methyl-2-(2,4,6-trichlorophenyl)-ethyl]-amide.

In further embodiments, a fungicide includes at least one or more of fludioxonil or thiabendazole.

In further embodiments, a fungicide includes at least one or more of prothioconazole or 3-difluoromethyl-1-methyl-1H-pyrazole-4-carboxylic acid methoxy-[1-methyl-2-(2,4,6-trichlorophenyl)-ethyl]-amide.

In various embodiments, at least one herbicide safener is combined with at least one fungicide.

In particular embodiments, the herbicide safener includes at least one of cloquintocet-methyl, cyprosulfamide, cumyluron, daimuron, dimepiperate, fenchlorazole-ethyl, isoxadifen-ethyl, mefenpyr-diethyl, and N-(2-methoxybenzoyl)-4-[(methylaminocarbonyl)amino]benzenesulfonamide, and the fungicide includes at least one of fludioxonil, thiabendazole, triticonzole, ipconazole, prothioconazole, prochloraz, carbendazim, thiram, oxpoconazole, triflumizole, pefurazoate, metconazole, fluoxastrobin, azoxystrobin, pyraclostrobin, trifloxystrobin, picoxystrobin, guazatine, tebuconazole, tetraconazole, imazalil, epoxiconzole, carboxin, fluquinconazole, and 3-difluoromethyl-1-methyl-1H-pyrazole-4-carboxylic acid methoxy-[1-methyl-2-(2,4,6-trichlorophenyl)-ethyl]-amide.

In particular embodiments, the herbicide safener includes at least one of cloquintocet-methyl, cyprosulfamide, cumyluron, daimuron, dimepiperate, fenchlorazole-ethyl, isoxadifen-ethyl, mefenpyr-diethyl, and N-(2-methoxybenzoyl)-4-[(methylaminocarbonyl)amino]benzenesulfonamide; and the fungicide includes at least one of fludioxonil, or thiabendazole.

In particular embodiments, the herbicide safener includes at least one of cloquintocet-methyl, cyprosulfamide, cumyluron, daimuron, dimepiperate, fenchlorazole-ethyl, isoxadifen-ethyl, mefenpyr-diethyl, and N-(2-methoxybenzoyl)-4-[(methylaminocarbonyl)amino]benzenesulfonamide; and the fungicide includes at least one of prothioconazole or 3-difluoromethyl-1-methyl-1H-pyrazole-4-carboxylic acid methoxy-[1-methyl-2-(2,4,6-trichlorophenyl)-ethyl]-amide.

In particular embodiments, the herbicide safener includes at least one of from cloquintocet-methyl and N-(2-methoxybenzoyl)-4-[(methylaminocarbonyl)amino]benzenesulfonamide; the fungicide is at least one or more of fludioxonil, or thiabendazole.

In a preferred embodiment, the herbicide safener includes at least one of cloquintocet-methyl and N-(2-methoxybenzoyl)-4-[(methylaminocarbonyl)amino]benzenesulfonamide; the fungicide is at least one or more of prothioconazole or 3-difluoromethyl-1-methyl-1H-pyrazole-4-carboxylic acid methoxy-[1-methyl-2-(2,4,6-trichlorophenyl)-ethyl]-amide.

Aflatoxins comprise one or more of aflatoxin B₁, B₂, G₁, G₂, M₁ and M₂; cytochalasins comprise one or more of the cytochalasin A, cytochalasin B, cytochalasin C, cytochalasin D, cytochalasin E, cytochalasin H, cytochalasin J; enniatins comprise one or more of enniatin A, enniatin A₁, enniatin A₂, enniatin B, enniatin B₁, enniatin B₄, enniatin C, enniatin D, enniatin E, and Enniatin F; ergot alkaloids comprise ergotamine and eroline; fumonisins comprise one or more of fumonisin B₁, fumonisin B₂, fumonisin B₃, fumonisin B₄, fumonisin A₁, fumonisin A₂, fumonisin A₃, fumonisin P₁, fumonisin P₂, and fumonisin P₃; fusarins comprise one or more of fusarin A, fusarin C, fusarin D, fusarin E, and fusarin F; ochratoxins comprise one or more of ochratoxin A, ochratoxin B, and ochratoxin C; trichothecenes comprise one or more of isotrichodermol, isotrichodermin, calonectrin, 3-deacetylcalonectrin, 15-deacetylcalonectrin, 3,15-dideacetylcalonectrin, 15-acetoxyscirpenol, 4,15-diacetoxyscirpenol, 3,4,15-triacetoxyscirpenol, neosolaniol, 3-acetylneosolaniol, nivalenol, 4-acetylnivalenol, 3,15-diacetylnivalenol, 4,15-diacetylnivalenol, deoxynivalenol (DON), 3-acetyldeoxynivalenol, 15-acetyldeoxynivalenol, 3,15-diacetyldeoxynivalenol, 3-acetyl-T-2 toxin, 4,7,15-acetylnivalenol T-2 Toxin, HT2 Toxin, scirpentriol, Diacetoxyscirpenol (DAS), and acyl derivatives thereof; zearalenones comprise one or more of zearalenone, α- and β-zearalenol, α- and β-zearaleanol, 11-hydroxyzearalenone, 14-hydroxyzearalenone, 4-acetylzearalenone, and 5-formylzearalenone.

In various embodiments, mycotoxins are selected from aflatoxin B₁, B₂, G₁, G₂; ergotamine; fumonisin B₁, fumonisin B₂, fumonisin B₃; deoxynivalenol (DON) and acetylated derivatives thereof; and zearalenone.

In various embodiments, mycotoxins are selected from fumonisin B₁, fumonisin B₂, fumonisin B₃.

In various embodiments, mycotoxins are selected from deoxynivalenol (DON) and acetylated derivatives thereof.

Fungi which produce mycotoxins and related secondary metabolites include:
Alternaria, including A. arborescens, A. arbusti, A. blumeae, A. brassicae, A. brassicicola A. brunsii; A. carotiincultae, A. conjuncta, A. dauci, A. euphorbiicola, A. gaisen, A. infectoria, A. japonica, A. molesta, A. panax, A. petroselini, A. selini A. solani A. smyrnii;
Aspergillus, including A. flavus, A. clavatus, A. niger A. parasiticus, A. nomius, A. ochraceus, A. carbonarius, A. versicolor;
Cephalosporium, including C. Gramineum;
Claviceps, including C. africana, C. fusiformis, C. paspali, C. purpurea;
Fusarium, including F. acuminatum, F. crookwellense, F. verticillioides, F. culmorum, F. avenaceum, F. equiseti, F. moniliforme, F. graminearum, F. lateritium, F. poae, F. sambucinum (G. pulicaris), F. proliferatum, F. Subglutinans, F. sporotrichioides;
Gibberella, including G. acuminata G. avenacea, G. baccata, G. carcinata, G. coronicola, G. cyanogena, G. fujikuroi, Gibberella intermedia, G. lagerheimii, G. moniliformis, G. nygamai, G. phyllostachydicola, G. pulicaris, G. stilboides, G. subglutinans, G. thapsina, G. tricincta, G. xylarioides, G. zeae;
Myrothecium, including M. roridum;
Paecilomyces, including P. lilacinus, P. ramosus, and P. viridis;
Penicillimum, including P. verrucosum, and P. viridicatum; P. expansum, P. funiculosum; P. cyclopium P. cyclopium, P. griseofulvum, and P. camembertii;
Stachybotrys, including S. chartarum, S. cylindrospora;
Trichoderma including T. harzianum, T. koningii, T. longibrachiatum, T. pseudokoningii, T. viride;
Trichothecium, including T. roseum; and,
Verticimonosporium, including V. verticale.

In particular embodiments, fungi which produce mycotoxins are selected from:
F. verticillioides, F. graminearum, F. acuminatum, F. crookwellense, F. culmorum, F. avenaceum, F. equiseti, F. moniliforme, F. lateritium, F. poae, F. sambucinum, F. proliferatum, F. subglutinans and F. sporotrichioides;
A. flavus, A. parasiticus and A. nomius, A. ochraceus, A. carbonarius; and,
P. viridicatum.

In very particular embodiments, fungi which produce mycotoxins are selected from: F. verticillioides, F. graminearum, F. culmorum, F. moniliforme, Aspergillus flavus, A. parasiticus, A. nomius, A. ochraceus and A. carbonarius.

In very particular embodiments, fungi which produce the mycotoxins are selected from: F. verticillioides and F. graminearum.

In very particular embodiments, fungi which produce the mycotoxins are selected from: A. flavus and A. parasiticus.

In some embodiments, crops and plants treated with various aspects and embodiments of the invention have less accumulation of mycotoxin and secondary fungal metabolite contamination than untreated crops and plants. Harvested plant material obtained from crops and plants treated with various aspects and embodiments of the invention will have less accumulation of mycotoxin and secondary fungal metabolite contamination than harvested plant material from untreated crops and plants.

In some embodiments, crops and plants treated with various aspects and embodiments of the invention have less infection of mycotoxin-producing pathogens than untreated crops and plants. Harvested plant material obtained from crops and plants treated with various aspects and embodiments of the invention will have less infection of mycotoxin-producing pathogens than harvested plant material from untreated crops and plants.

In some embodiments, crops and plants treated with various aspects and embodiments of the invention have less disease, including Fusarium Head Blight, related to mycotoxin-producing pathogen infection than untreated crops and plants. Harvested plant material obtained from crops and plants treated with various aspects and embodiments of the invention will have less disease, including Fusarium Head Blight, related to mycotoxin-producing pathogen infection than harvested plant material from untreated crops and plants.

In various embodiments, crops and plants and harvested plant material obtained from crops and plants treated with the present aspects and embodiments have at least 10% less accumulation of mycotoxin and secondary fungal metabolite contamination, more preferable at least 20% less accumulation of mycotoxin and secondary fungal metabolite contamination, more preferably at least 30% less accumulation of mycotoxin and secondary fungal metabolite contamination, more preferably at least 40% less accumulation of mycotoxin and secondary fungal metabolite contamination, more preferably at least 50% less accumulation of mycotoxin and secondary fungal metabolite contamination, more preferably at least 60% less accumulation of mycotoxin and secondary fungal metabolite contamination, more preferably at least 70% less accumulation of mycotoxin and secondary fungal metabolite contamination, and more preferably at least 80% less accumulation of mycotoxin and secondary fungal metabolite contamination than untreated crops and plants or harvested plant material obtained from untreated crops and plants.

In various embodiments, crops and plants and harvested plant material obtained from crops and plants treated with the present aspects and embodiments have at least 10% less infection of mycotoxin-producing pathogens, more preferable at least 20% less infection of mycotoxin-producing pathogens, more preferably at least 30% less infection of mycotoxin-producing pathogens, more preferably at least 40% less infection of mycotoxin-producing pathogens, more preferably at least 50% less infection of mycotoxin-producing pathogens, more preferably at least 60% less infection of mycotoxin-producing pathogens, more preferably at least 70% less infection of mycotoxin-producing pathogens, and more preferably at least 80% less infection of mycotoxin-producing pathogens than untreated crops and plants or harvested plant material obtained from untreated crops and plants.

In various embodiments, crops and plants and harvested plant material obtained from crops and plants treated with the present aspects and embodiments have at least 10% less disease related to mycotoxin-producing pathogen infection, more preferable at least 20% less disease related to mycotoxin-producing pathogen infection, more preferably at least 30% less disease related to mycotoxin-producing pathogen infection, more preferably at least 40% less disease related to mycotoxin-producing pathogen infection, more preferably at least 50% less disease related to mycotoxin-producing pathogen infection, more preferably at least 60% less disease related to mycotoxin-producing pathogen infection, more preferably at least 70% less disease related to mycotoxin-producing pathogen infection, and more preferably at least 80% less disease related to mycotoxin-producing pathogen infection than untreated crops and plants or harvested plant material obtained from untreated crops and plants.

A single pesticidal active ingredient may have activity in more than area of pest control, for example, a pesticide may have fungicide, insecticide and nematicide activity. Specifically, aldicarb is known for insecticide, acaricide and nematicide activity, while metam is known for insecticide, herbicide, fungicide and nematicide activity, and thiabendazole and captan can provide nematicide and fungicide activity.

Herbicide safeners are optionally combined with one or more of additional active ingredients, such as one or more pesticidal ingredients, including insecticides, fungicides, bactericides, nematicides, molluscicides, as well as bird repellents, growth regulators (plant growth regulators), biological agents, fertilizers, micronutrient donors or other preparations that influence plant growth, such as inoculants, and/or mixtures thereof. Combinations may be applied together, separate, and/or sequentially.

Rates of application for herbicide safeners vary according to a variety of factors, including, for example, the type of safener selected, optionally other active ingredients selected, inactive ingredients selected, type of crop selected, mycotoxin contamination or contamination potential, secondary fungal metabolite contamination or contamination potential, infection or infection potential of mycotoxin-producing pathogens, disease or disease potential related to mycotoxin-producing pathogen infection, other disease pressure, weed pressure, and other relevant agronomic conditions, among others. The application rate selected is such that the safener provides the desired reduction in mycotoxins and effects of mycotoxin contamination and can be determined by trials.

In various aspects and embodiments of the invention, safeners and optional additional active ingredients are each independently, generally and advantageously formulated as follows:
for foliar treatments: from 0.1 to 10,000 g/ha, preferably from 5 to 500 g/ha, more preferably from 50 to 200 g/ha; and more preferably at about 100 g/ha; in case of drench or drip application, the rates can be reduced; and,
for soil treatments: from 0.1 to 10,000 g/ha, preferably from 1 to 5,000 g/ha.

In one embodiment, isoxadifen is applied to wheat at a rate of about 100 g/ha, and optionally with prothioconazole at a rate of 50 g/ha. In another embodiment, cyprosulfamide is applied to corn at a rate of about 100 g/ha, and optionally with prothioconazole at a rate of about 100 g/ha.

The rates and/or doses herein indicated are given as illustrative examples of the aspects and embodiments of the invention. A person skilled in the art will know how to adapt the application doses, notably according to the nature of the plant or crop to be treated.

The aspects and embodiments may also be useful to treat roots and the over-ground parts of the crops and plant such as maize, including sterns, ears, tassels, silks, cobs and kernels and the like of the concerned plant, and such as wheat. For wheat, for example, treatment of over-ground parts would primarily consist of applications of safener alone and/or in combination with fungicide(s) on the developing spikelets, or ears, of wheat plants which comprise the florets, or reproductive structures which will eventually mature to form the seeds of the harvested plant.

Combinations and mixtures, and compositions containing combinations and mixtures, of the invention may be expressed according to weight ratios. Preferably, the ratios are selected according to a variety of factors, including: the type of safener selected, optionally other active ingredients selected, inactive ingredients selected, type of crop selected, mycotoxin contamination or contamination potential, secondary fungal metabolite contamination or contamination potential, infection or infection potential of mycotoxin-producing pathogens, disease or disease potential related to mycotoxin-producing pathogen infection, other disease pressure, weed pressure, and other relevant agronomic conditions, among others. In general, combinations of the invention are present in a weight ratio of a herbicide safener and one or more additional active ingredients, preferably a fungicide, in a range of about 100:1 to about 1:100, more preferably in a weight ratio of about 50:1 to about 1:50, more preferably about 1:10 to about 10:1, more preferably at about 3:1 to about 1:3, more preferably about 2:1 to about 1:2, and more preferably about 1:1.

Combinations of the present invention include formulated mixtures such as a “pre-mix” or “ready-mix” forms, combined mixtures composed from separate formulations of the single active ingredients, such as a “tank-mix”, and in a combined use of a two or more single active ingredients applied in a sequential manner, i.e. one after the other with a reasonably short period, such as a few hours or days. Preferably, the herbicide safener is formulated as a pre-mix or tank-mix when used in combination with at least one other active ingredient, such as a fungicide.

Combination, mixtures, and the like, are applied sequentially, or simultaneously, or in any other suitable sequence.

The BBCH-scale is a scale used to identify the phenological development stages of agricultural crop plants. A series of BBCH-scales have been developed for a range of crop species, including corn and wheat. Lancashire, P. D.; H. Bleiholder, P. Langeluddecke, R. Stauss, T. van den Boom, E. Weber, A. Witzen-Berger (1991). “An uniform decimal code for growth stages of crops and weeds.” Ann. appl. Biol. 119: 561-601. The subject matter of references cited is incorporated herein by reference. The BBCH-identification keys and phenological growth stages (“GS”) for maize are as follows:

| Growth stage | Code | Description |
|---|---|---|
| 0: Germination | 00 | Dry seed (caryopsis) |
| | 01 | Beginning of seed imbibition |
| | 03 | Seed imbibition complete |
| | 05 | Radicle emerged from caryopsis |
| | 06 | Radicle elongated, root hairs and/ |
| | | or side roots visible |
| | 07 | Coleptile emerged from caryopsis |
| | 09 | Emergence: coleoptile penetrates |
| | | soil surface (cracking stage) |
| 1: Leaf | 10 | First leaf through coleoptile |
| development | 11 | First leaf unfolded |
| | 12 | 2 leaves unfolded |
| | 13 | 3 leaves unfolded |
| | 14 | 4 leaves unfolded. Growth stages |
| | | continuous by leaf development |
| | 19 | 9 or more leaves unfolded |
| 3: Stem | 30 | Beginning of stem elongation |
| elongation | 31 | First node detectable |
| | 32 | 2 nodes detectable |
| | 33 | 3 nodes detectable |
| | 34 | Stages continuous till . . . |
| | 39 | 9 or more nodes detectable |
| 5: Inflorescence | 51 | Beginning of tassel emergence: |
| emergence, | | tassel detectable at top of stem |
| heading | 53 | Tip of tassel visible |
| | 55 | Middle of tassel emergence: middle |
| | | of tassel begins to separate |
| | 59 | End of tassel emergence: tassel fully |
| | | emerged and separated |
| 6: Flowering, | 61 | Male: stamens in middle of tassel visible |
| anthesis | | Female: tip of ear emerging from leaf |
| | | sheath |
| | 63 | Male: beginning of pollen shedding |
| | | Female: tips of stigmata visible |
| | 65 | Male: upper and lower parts of tassel in |
| | | flower |
| | | Female: stigmata fully emerged |
| | 67 | Male: flowering completed |
| | | Female: stigmata drying |
| | 69 | End of flowering: stigmata completely |
| | | dry |
| 7: Development | 71 | Beginning of grain development: kernels |
| of fruit | | at blister stage, about 16% dry matter |
| | 73 | Early milk |
| | 75 | Kernels in middle of cob yellowish- |
| | | white (variety-dependent), content milky, |
| | | about 40% dry matter |
| | 79 | Nearly all kernels have reached final size |
| 8: Ripening | 83 | Early dough: kernel content soft, about |
| | | 45% dry matter |
| | 85 | Dough stage: kernels yellowish to yellow |
| | | (variety dependent), about 55% dry matter |
| | 87 | Physiological maturity: black dot/layer |
| | | visible at base of kernels, about 60% dry |
| | | matter |
| | 89 | Fully ripe: kernels hard and shiny, about |
| | | 65% dry matter |
| 9: Senescence | 97 | Plant dead and collapsing |
| | 99 | Harvested product |

In accordance with various aspects and embodiments, the herbicide safener is applied to maize at defined growth stages and/or phenological stages. In one embodiment, the herbicide safener is applied to maize after about GS 18-19. Preferably, the herbicide safener is applied to maize on or after about GS 5 (51-59) to about GS 7 (71-79), corresponding to inflorescence emergence (beginning of tassel emergence through end of tassel emergence) to development of fruit (beginning of grain development through nearly all kernels having reached final size). More preferably, the herbicide safener is applied to maize on or after about GS 59.

In accordance with additional aspects and embodiments, the herbicide safener is applied in combination with at least one additional active ingredient to maize, at defined growth stages and/or physiological stages. Preferably, the additional active ingredient is a fungicide. In various embodiments, the herbicide safener is applied in combination with a fungicide to maize after about GS 18-19. Preferably, the herbicide safener is applied in combination with a fungicide to wheat on or after about GS 51 to about GS 79. Preferably, the herbicide safener is applied in combination with a fungicide to wheat on about GS 59.

Particularly effective treatments for maize include sole treatments of isoxadifen and combination treatments cyprosulfamide and prothioconazole.

The BBCH-identification keys and phenological growth stages (“GS”) of cereals (e.g., wheat) are as follows:

| Growth stage | Code | Description |
|---|---|---|
| 0: Germination | 00 | Dry seed (caryopsis) |
| | 01 | Beginning of seed imbibitions |
| | 03 | Seed imbibition complete |
| | 05 | Radicle emerged from caryopsis |
| | 06 | Radicle elongated, root hairs and/ |
| | | or side roots visible |
| | 07 | Coleoptile emerged from caryopsis |
| | 09 | Emergence: coleoptile penetrates |
| | | soil surface (cracking stage) |
| 1: Leaf development^{1,2} | 10 | First leaf through coleoptiles |
| | 11 | First leaf unfolded |
| | 12 | 2 leaves unfolded |
| | 13 | 3 leaves unfolded |
| | 1. | Stages continuous till . . . |
| | 19 | 9 or more leaves unfolded |
| 2: Tillering³ | 20 | No tillers |
| | 21 | Beginning of tillering: first |
| | | tiller detectable |
| | 22 | 2 tillers detectable |
| | 23 | 3 tillers detectable |
| | 2. | Stages continuous till . . . |
| | 29 | End of tillering. Maximum no. |
| | | of tillers detectable |
| 3: Stem elongation | 30 | Beginning of stem elongation: |
| | | pseudostem and tillers erect, |
| | | first internode begins to elongate, |
| | | top of inflorescence at least 1 cm |
| | | above tillering node |
| | 31 | First node at least 1 cm above |
| | | tillering node |
| | 32 | Node 2 at least 2 cm above node 1 |
| | 33 | Node 3 at least 2 cm above node 2 |
| | 3. | Stages continuous till .. . |
| | 37 | Flag leaf just visible, still rolled |
| | 39 | Flag leaf stage: flag leaf fully |
| | | unrolled, ligule just visible |
| 4: Booting | 41 | Early boot stage: flag leaf sheath |
| | | extending |
| | 43 | Mid boot stage: flag leaf sheath |
| | | just visibly swollen |
| | 45 | Late boot stage: flag leaf sheath |
| | | swollen |
| | 47 | Flag leaf sheath opening |
| | 49 | First awns visible (in awned forms |
| | | only) |
| 5: Inflorescence | 51 | Beginning of heading: tip of |
| emergence, heading | | inflorescence emerged from sheath, |
| | | first spikelet just visible |
| | 52 | 20% of inflorescence emerged |
| | 53 | 30% of inflorescence emerged |
| | 54 | 40% of inflorescence emerged |
| | 55 | Middle of heading: half of |
| | | inflorescence emerged |
| | 56 | 60% of inflorescence emerged |
| | 57 | 70% of inflorescence emerged |
| | 58 | 80% of inflorescence emerged |
| | 59 | End of heading: inflorescence |
| | | fully emerged |
| 6: Flowering, anthesis | 61 | Beginning of flowering: first |
| | | anthers visible |
| | 65 | Full flowering: 50% of anthers |
| | | mature |
| | 69 | End of flowering: all spikelets |
| | | have completed flowering but |
| | | some dehydrated anthers may |
| | | remain |
| 7: Development of fruit | 71 | Watery ripe: first grains have |
| | | reached half their final size |
| | 73 | Early milk |
| | 75 | Medium milk: grain content |
| | | milky, grains reached final |
| | | size, still green |
| | 77 | Late milk |
| 8: Ripening | 83 | Early dough |
| | 85 | Soft dough: grain content soft |
| | | but dry. Fingernail impression |
| | | not held |
| | 87 | Hard dough: grain content solid. |
| | | Fingernail impression held |
| | 89 | Fully ripe: grain hard, difficult to |
| | | divide with thumbnail |
| 9: Senescence | 92 | Over-ripe: grain very hard, cannot |
| | | be dented by thumbnail |
| | 93 | Grains loosening in day-time |
| | 97 | Plant dead and collapsing |
| | 99 | Harvested product |

¹A leaf is unfolded when its ligule is visible or the tip of the next leaf is visible.
²Tillering or stem elongation may occur earlier than stage 13; in this case continue with stages 21.
³If stem elongation begins before the end of tillering continue with stage 30.

In accordance with additional aspects and embodiments, the herbicide safener is applied to cereals, specifically wheat, at defined growth stages and/or phonological stages. In various embodiments, the herbicide safener is applied to wheat on or after about GS 3 (39) to about GS 6 (69), corresponding to stem elongation (final flag leaf stage) to anthesis (end of flowering). In various preferred embodiments, the herbicide safener is applied to wheat on or after GS 5 (59), corresponding to inflorescence emergence (end of heading, inflorescence fully emerged), to about GS 6 (69), corresponding to flowering (end of flowering). In a further preferred embodiment, the herbicide safener is applied to wheat on or after about GS 3 (39), corresponding to stem elongation (final flag leaf stage).

In further preferred embodiments, the herbicide safener is applied to wheat about GS 59.

Particularly effective treatments for wheat include sole treatments of isoxadifen and combination treatments of isoxadifen and prothioconazole.

In accordance with other aspects and embodiments, the herbicide safener is applied in combination with at least one additional active ingredient to cereals, specifically wheat, at defined growth stages and/or phenological stages. Preferably, the additional active ingredient is a fungicide. Preferably, the herbicide safener is applied in combination with a fungicide to wheat on or after about GS 39 to about GS 69. In various embodiments, the herbicide safener is applied in combination with a fungicide to wheat on or after about GS 39. In various preferred embodiments, the herbicide safener is applied in combination with a fungicide to wheat on or about GS 65.

In accordance with other aspects and embodiments, a system and methods are provided for determining the need of an agricultural crop or plant for application one or more herbicide safeners, optionally with one or more additional active ingredients, to reduce accumulation or accumulation potential of mycotoxin and secondary and fungal metabolites in a crop, plant or harvested plant material. In further aspects and embodiments, a system and methods are provided for determining the efficacy of an agent to reduce the accumulation or accumulation potential of mycotoxin and secondary and fungal metabolites in a crop, plant, or harvested plant material. Various embodiments include a system for determining the accumulation or accumulation potential of mycotoxins or secondary fungal metabolites in a crop, plant, or harvested plant material and the application of at least one herbicide safener, and optionally at least one other active ingredient, preferably a fungicide. Further embodiments include, optionally determining the amount of mycotoxin accumulation and secondary fungal metabolite accumulation present relative to an untreated control. Further embodiments include, optionally inoculating the crop or plant with a mycotoxin-producing pathogen prior to the application of the safener, optionally in combination with at least one additional active ingredient. Further embodiments include, optionally inoculating the crop or plant with a mycotoxin-producing pathogen subsequent to the application of the safener, optionally in combination with at least one additional active ingredient. Preferably, the plant is an agricultural crop, more preferably corn or wheat.

In accordance with other aspects and embodiments, a system and methods are provided for determining the need of an agricultural crop or plant for application of one or more herbicide safeners, optionally with one or more additional active ingredients, to reduce the infection or infection potential of mycotoxin-producing pathogens in an agricultural crop, plant, or harvested plant material. In further aspects and embodiments, a system and methods are provided for determining the efficacy of an agent to reduce the infection or infection potential of mycotoxin-producing pathogens in a crop, plant, or harvested plant material. Various embodiments include a system for determining the infection or infection potential of mycotoxin-producing pathogens in a crop, plant, or harvested plant material, and the application of at least one herbicide safener, and optionally at least one other active ingredient, preferably a fungicide. Further embodiments include, optionally determining the amount of mycotoxin-producing pathogen infection present by calculating the area of the plant impacted or infected by the pathogen relative to the total area of the plant, optionally expressed as a percentage. Further embodiments include, optionally determining the amount of infection of mycotoxin-producing pathogens present relative to an untreated control. Further embodiments include, optionally inoculating the plant with a mycotoxin-producing pathogen prior to the application of the safener, optionally in combination with at least one additional active ingredient. Further embodiments include, optionally inoculating the plant with a mycotoxin-producing pathogen subsequent to the application of the safener, optionally in combination with at least one additional active ingredient. Preferably, the plant is an agricultural crop, more preferably corn or wheat.

In accordance with other aspects and embodiments, a system and methods are provided for determining the need of an agricultural crop or plant for application of one or more of a herbicide safeners, optionally with one or more additional active ingredients, to reduce disease or disease potential, including Fusarium Head Blight, related a to mycotoxin-producing pathogen in a crop, plant, or harvested plant material. In further aspects and embodiments, a system and methods are provided for determining the efficacy of an agent to reduce disease or disease potential, including Fusarium Head Blight, related a to mycotoxin-producing pathogen in a crop, plant, or harvested plant material. Various embodiments include a system for determining the amount of disease or disease potential present in a crop, plant, or harvested plant material. The system further includes the application of at least one herbicide safener, and optionally at least one other active ingredient, preferably a fungicide. Further embodiments include, optionally determining the amount of disease present by calculating the area of the plant impacted by disease relative to the total area of the plant, optionally expressed as a percentage. Further embodiments include, optionally determining the amount of disease present relative to an untreated control. Further embodiments include, optionally inoculating the plant with a mycotoxin-producing pathogen prior to the application of the safener, optionally in combination with at least one additional active ingredient. Further embodiments include, optionally inoculating the plant with a mycotoxin-producing pathogen subsequent to the application of the safener, optionally in combination with at least one additional active ingredient. Preferably, the plant is an agricultural crop, more preferably corn or wheat.

In accordance with other aspects and embodiments, an agricultural crop or plant is provided, where the crop or plant is treated with one or more herbicide safeners, optionally with one or more additional active ingredients, preferably a fungicide, optionally in the absence of a co-applied herbicide. In various embodiments, the crop or plant is treated with a combination of a herbicide safener and a fungicide. In further embodiments, the combination is applied as a formulated “pre-mix.” In further embodiments, the combination is applied as a “tank-mix.” The combination is applied sequentially, or simultaneously, or in any other suitable sequence.

The invention further provides compositions and methods for enhancing yield and/or vigor of agricultural crops. This aspect includes the selection and/or application of one or more herbicide safeners, with one or more optional additional active ingredients, including a fungicide, directed against a specified pathogen known to affect yield and/or vigor. In other aspects, the safener and optional fungicide are selected to treat the mechanism of virulence associated with a particular pathogen. Examples of yield- and/or vigor-affecting pathogens include Fusarium graminearum, F. avenaceum, F. culmorum, F. poae, F. equiseti, F. sporotrichioides, F. acuminatum, F. subglutinans, F. oxysporum, F. verticillioides, F. proliferatum, etc. Examples of mycotoxin-specific mechanisms of virulence associated with these pathogens include the production of mycotoxins such as: Trichothecene (e.g., deoxynivalenol, 15-acetyl-deoxynivalenol, 3-acetyl-deoxynivalenol, T2 Toxin, nivalenol, diacetoxyscirpenol, etc.); Fumonisins (e.g., B₁, B₂, B₃, B₄, A₁, A₂, A₃, P₁, P₂, P₃); Moniliformin; Beauvericin; Enniatins (e.g. A, A₁, A₂, B, B₁, B₄, C, D, E, F), Fusaproliferin, Fusaric Acid. Enhancements to yield and/or vigor may be determined by any suitable method. In the case of maize, such enhancements may be determined by comparing number of kernels per maize cob or by assessing physical characteristics of grain quality such as thousand kernel weight (i.e., mass of 1,000 seeds) and the hectoliter weight (i.e., mass of one liter of grain) of maize in treated versus untreated samples. In an exemplary embodiment, a safener (e.g., cloquintocet, cyprosulfamide, 3-difluoromethyl-1-methyl-1H-pyrazole-4-carboxylic acid methoxy-[1-methyl-2-(2,4,6-trichlorophenyl)-ethyl]-amide) plus a fungicide (e.g., prothioconazole) is applied to maize infected with Fusarium verticillioides and Fusarium graminearum which is known to produce trichothecene and Fumonisin mycotoxins as mechanism of virulence during fungal pathogenesis.

The invention further provides compositions and methods for controlling fungal pathogenesis in agricultural crops, plants, and harvested plant material. This aspect includes one or more herbicide safeners, optionally with one or more additional active ingredients, including a fungicide, optionally in the absence of a herbicide.

Even distribution of the active ingredients and adherence thereof to plants, plant material, and post harvest material is desired. Applications may vary from a thin film (dressing) of compositions and formulation containing the active ingredient(s) on a plant, plant material, and post harvest material, where the original size and/or shape are recognizable to an intermediary state (such as a coating) and then to a thicker film (such as pelleting with many layers of different materials (such as carriers, for example, clays; different formulations, such as of other active ingredients; polymers; and colorants).

The reduction in mycotoxin contamination is preferably carried out by treating the soil and the above-ground parts of plants with a safener, optionally in combination with other active ingredients. Efforts may be employed to reduce the amount of active ingredients applied.

Among others, the invention provides a novel advantage for treatment and prevention of reducing mycotoxin accumulation and related fungal infection and disease and in agricultural crops, plants, or harvested plant material, with application, treatment, and/or use of one or more herbicide safeners. Herbicide safeners with other active ingredients, particularly fungicides, according to the present invention demonstrate additive effects and superadditive (“synergistic”) effects, depending on the plant species or cultivars, location and growth conditions (soils, climate, vegetation period, diet), among others. Such effects include: reduced application rates; enhanced activity spectrum; increased activity and/or potency of the active ingredients and compositions; enhanced plant growth; increased stress tolerance; increased tolerance to high or low temperatures; increased tolerance to drought, over watered conditions, and irregular soil salt content; increased plant performance; enhanced harvesting; accelerated maturation; higher harvest yields; bigger fruits and flowers; larger plant height; increased root mass; greener leaf color; earlier flowering; enhanced nutritional value of the harvested plant material; elevated sugar content; improved storage stability and/or processability of the harvested plant material; among others; which exceed the effects, characteristics, or results expected.

A further advantage is the synergistic increase in activity of the combinations and compositions comprising combinations of active ingredients of the invention in comparison to the respective individual activity of each compound alone, which extends beyond the sum of the activity of both active ingredients applied individually. In this way an optimization of the amount of active compound applied is made possible.

Treatment includes the preventative and/or curative action of at least one herbicide safener, optionally in combination with at least one additional active ingredient, preferably a fungicide, in response to a significant mycotoxin accumulation potential or secondary fungal metabolite accumulation potential, and/or in response to a significant infection potential of mycotoxin-producing pathogens in agricultural crops, and/or in response to a significant disease potential, including Fusarium Head Blight, related to mycotoxin-producing pathogen infection. Treatment includes such applications before, during, or after mycotoxin accumulation or secondary fungal metabolite accumulation. Treatment further includes such applications before, during, or after infection of mycotoxin-producing pathogens in agricultural crops. Treatment further includes such applications before, during, or after the onset of disease, including Fusarium Head Blight, in crops, plants, and harvested plant material.

The treatment of plants and plant parts is carried out directly or by action on their environment, habitat or storage area by means of the normal treatment methods, for example by watering (drenching), drip irrigation, spraying, vaporizing, atomizing, broadcasting, dusting, foaming, spreading-on, a powder, a solution, a water-soluble powder, a water-soluble powder for slurry treatment, or by encrusting, in the case of plant material, dry treatments, and slurry treatments, liquid treatments, including one- or multi-layer coatings. It is possible to apply the active ingredients by the ultra-low volume methods, or to inject the active ingredients into the soil.

Herbicide safeners and other active ingredients may be used in unmodified form but is normally used in the form of compositions. The active ingredients can be applied together with further carriers, surfactants or other application-promoting adjuvants customarily employed in formulation technology. Suitable carriers and adjuvants can be solid or liquid and are the substances ordinarily employed in formulation technology, e.g. natural or regenerated mineral substances, solvents, dispersants, wetting agents, tackifiers, thickeners, binders or fertilizers.

Suitable solvents include, but are not limited to: aromatic hydrocarbons, preferably the fractions containing 8 to 12 carbon atoms, e.g. xylene mixtures or substituted naphthalenes; phthalates, such as dibutyl phthalate or dioctyl phthalate; aliphatic hydrocarbons, such as cyclohexane or paraffins; alcohols and glycols and their ethers and esters, such as ethanol, ethylene glycol, ethylene glycol monomethyl or monoethyl ether; ketones, such as cyclohexanone; strongly polar solvents, such as N-methyl-2-pyrrolidone, dimethyl sulphoxide or dimethylformamide, as well as vegetable oils or epoxidised vegetable oils, such as epoxidised coconut oil or soybean oil; or water.

The solid carriers used, e.g. for dusts and dispersible powders, are normally natural mineral fillers, such as calcite, talcum, kaolin, montmorillonite or attapulgite. In order to improve the physical properties it is also possible to add highly dispersed silicic acid or highly dispersed absorbent polymers. Suitable granulated adsorptive carriers are porous types, for example pumice, broken brick, sepiolite or bentonite, and suitable nonsorbent carriers are, for example, calcite or sand. In addition, a great number of pregranulated materials of inorganic or organic nature can be used, e.g. especially dolomite or pulverised plant residues.

Additional components may be added to compositions and formulations of the invention, in particular a surface-active composition, or a “surfactant,” which may be one or more surfactant or a mixture of surfactants. Surfactants include emulsifiers, dispersing agents or wetting agents of an ionic or non-ionic type or a mixture of such surfactants. For example, surfactants include polyacrylic acid salts, lignosulphonic acid salts, phenolsulphonic or naphthalenesulphonic acid salts, polycondensates of ethylene oxide with fatty alcohols or with fatty acids or with fatty amines, substituted phenols (such as alkylphenols and arylphenols), salts of sulphosuccinic acid esters, taurine derivatives (such as alkyl taurates), phosphoric esters of polyoxyethylated alcohols or phenols, fatty acid esters of polyols, and derivatives of the present ingredients containing sulphate, sulphonate and phosphate functions, for example alkylaryl polyglycol ethers, alkyl sulphonates, alkyl sulphates, aryl sulphonates, protein hydrolyzates, lignosulphite waste liquors and methyl cellulose. In various embodiments, the presence of at least one surfactant is preferred when the active ingredient and/or the inert support are water-insoluble and when the vector agent for the application is water. In further embodiments, the surfactant content may be comprised from 5% to 40% by weight of the composition.

Emulsifiers include any suitable emulsifier and/or foam-forming agent, for example, non-ionic and anionic emulsifiers, such as polyoxyethylene (POE) esters and ethers, polyoxypropylene (POP) esters and ethers, POP-POE adducts, POE and/or POP polyol derivatives, POE and/or POP/sorbitan or sugar adducts, alkyl or aryl sulphates, sulphonates and phosphates. Optionally included are oligomers or polymers, for example, vinyl monomers, acrylic acid, alone or optionally in combination with (poly-) alcohols or (poly-amines). Optionally included are lignin and sulphonic acid derivatives thereof, simple and modified celluloses, and aromatic and/or aliphatic sulphonic acids and adducts thereof with formaldehyde.

Coloring agents are optionally included in compositions and formulations. Suitable colorants include those customarily used in agricultural compositions, such as inorganic pigments, including iron oxide, titanium oxide, ferrocyanblue, and organic pigments including alizarin, azo and metallophthalocyanine dyes, and trace elements including iron, manganese, boron, copper, cobalt, molybdenum and zinc salts. Further included are pigments, having low solubility in water, and of dyes, having high solubility in water. Examples include rhodamine B, C.I. Pigment Red 112, and C.L Solvent Red 1.

Wetting agents are optionally included in compositions and formulations, and include all substances which promote wetting and are customary in the formulation of active agrochemical substances, such as alkylnaphthalene-sulphonates, such as diisopropyl- or diisobutylnaphthalene-sulphonates.

Dispersing agents are optionally included in compositions and formulations and include all nonionic, anionic, and cationic dispersants which are customary in the formulation of active agrochemical substances.

Defoamers are optionally included in compositions and formulations and include all foam inhibiting substances which are customary in the formulation of active agrochemical substances, such as silicone defoamers and magnesium stearate.

Preservatives are optionally included in compositions and formulations and include all substances which can be used for such purposes in agrochemical compositions, such as dichlorophen and benzyl alcohol hemiformal.

Secondary thickeners are optionally included in compositions and formulations and include all substances which can be used for such purposes in agrochemical compositions, such as cellulose derivatives, acrylic acid derivatives, xanthan, modified clays, and highly disperse silica.

Adhesives are optionally included in compositions and formulations and include all customary binders which can be used in agrochemical compositions, such as polyvinylpyrrolidone, polyvinyl acetate, polyvinyl alcohol, tylose, carboxymethylcellulose, natural and synthetic powdered, granular or latex-like polymers such as gum arabic, natural phospholipids, such as cephalins and lecithins and synthetic phospholipids. Further additives can be mineral or vegetable oils and waxes, optionally modified.

Additional components are optionally included, such as, for example, colloids, thickeners, thixotropic agents, penetration agents, stabilizers, and sequestering agents. More generally, the safener can be combined with any solid or liquid additive, which complies with the usual formulation techniques.

Particularly advantageous application-promoting adjuvants are also natural or synthetic phospholipids of the cephalin and lecithin series, e.g. phosphatidylethanolamine, phosphatidylserine, phosphatidylglycerol and lysolecithin.

The active ingredients and compositions can be used as such, in formulations or as forms prepared therefrom. Formulations are prepared by any manner known in the art, e.g. by homogeneously mixing and/or grinding the active ingredients with extenders, e.g. solvents, solid carriers and, where appropriate, surface-active compounds (surfactants). Any formulated form is suitably used in the present invention, including aerosol dispensers, capsule suspensions, cold fogging concentrates, hot fogging concentrates, encapsulated granules, fine granules, flowable concentrates, ready-to-use solutions, dustable powders, emulsifiable concentrates, emulsion oil in water, emulsion water in oil, macrogranules, microgranules, oil dispersible powders, oil miscible flowable concentrates, oil miscible liquids, froths, paste, suspension concentrates (flowable concentrate), suspensions-emulsions concentrates, soluble concentrates, suspensions, soluble powders, granules, water soluble granules or tablets, water soluble powders, wettable powders, natural and synthetic materials impregnated with active ingredients, micro-encapsulation in polymeric materials, as well as UL V-cold and hot fogging formulations, gas (under pressure), gas generating product, powders, solutions, ultra low volume (ULV) liquids, ultra low volume (ULV) suspensions, water dispersible granules or tablets, and water dispersible powders.

In the event that the components are applied simultaneously, they may be applied as a composition containing each of the components, in which case each of the components can be obtained from a separate source and mixed together (known as a tank-mix, ready-to-apply, spray broth or slurry), optionally with other pesticides, or the components can be obtained as a single mixture source (known as a pre-mix, concentrate, formulated ingredient (or product)), and optionally mixed together with other pesticides.

Typically, a pre-mix formulation comprises 0.5 to 99.9%, especially 1 to 95%, active ingredients, and 99.5 to 0.1%, especially 99 to 5%, of a solid or liquid adjuvant (including, for example, a solvent such as water), where the auxiliaries can be a surfactant in an amount of 0 to 50%, especially 0.5 to 40%, based on the pre-mix formulation.

Whereas commercial products will preferably be formulated as concentrates (e.g., pre-mix composition (formulation)), the end user will normally employ dilute formulations (e.g., tank-mix composition).

Herbicide safeners, in general, are thought to selectively protect crop plants from herbicide damage without reducing activity in a target weed species. Commercial uses include improvement in herbicide selectivity between crop and weed species. Safeners are routinely applied as a mixture with herbicides. In accordance with the present invention, it has been surprisingly found that herbicide safeners, alone or in combination with fungicides and other ingredients, reduce fungal infection and mycotoxin accumulation in agricultural crops. While not wishing to be bound by any particular theory or mechanism, it is believed that the observed effects are related to enhanced metabolism and detoxification of mycotoxins and fungal metabolites into non-toxic compounds within the treated agricultural crops. Some of the important mechanisms for the observed effects are believed to include oxidative reactions (e.g., hydroxylations, oxidative dealkylations, etc.) catalyzed by safener-induced constitutive up-regulation of the cytochrome-P450 mono-oxygenase enzyme system as well as glutathione-S-transferase catalyzed conjugation reactions, which result in nucleophilic displacement of toxic moieties on mycotoxins and fungal metabolites to the tripeptide glutathione enzymes.

A synergistic effect exists, for example, whenever the action of a combination of active ingredients is greater than the sum of the actions of the individual components. The action to be expected E for a given active ingredient combination obeys the so-called COLBY formula and can be calculated as follows (COLBY, S. R. “Calculating synergistic and antagonistic responses of herbicide combination”. Weeds, Vol. 15, pages 20-22; 1967):

ppm=milligrams of active ingredient (=a.i.) per liter of spray mixture
X=% action by active ingredient A) using p ppm of active ingredient
Y=% action by active ingredient B) using q ppm of active ingredient.

According to COLBY, the expected (additive) action of active ingredients A)+B) using p+q ppm of active ingredient is

$$E = X + Y - \frac{X \cdot Y}{100}$$

If the action actually observed (O) is greater than the expected action (E), then the action of the combination is super-additive, i.e. there is a synergistic effect. In mathematical terms, synergism corresponds to a positive value for the difference of (O−E). In the case of purely complementary addition of activities (expected activity), said difference (O−E) is zero. A negative value of said difference (O−E) signals a loss of activity compared to the expected activity.

The following Examples are given by way of illustration and not by way of limitation of the invention.

### EXAMPLES

### Example 1

Spring wheat plants (variety ‘Monsun’) was grown in a greenhouse at 22° C., 12 hours of light/12 hours of dark using an experiment based on a randomized complete block (RCB) design with four replicates.

Group A treatments consisted of applications of the safeners: N-(2-methoxybenzoyl)-4-[(methylaminocarbonyl)amino]benzenesulfonamide; Cloqunitocet-mexyl; and Isoxadifen, each at use rates of 100 gai/ha at Growth Stage (GS) 59 at a water volume of 220 L/ha using a track sprayer. Untreated non-innoculated and inoculated control treatments were included at this GS59.

Group B treatments consisted of the following applications at GS 65 to 69: N-(2-methoxybenzoyl)-4-[(methylaminocarbonyl)amino]benzenesulfonamide; Cloqunitocet-mexyl; and Isoxadifen, safeners each at use rates of 100 gai/ha, as well as Prothioconazole fungicide at use rates of 100 and 200 gai/ha; and combination treatments of Prothioconazole fungicide at 100 gai/ha plus respective safener treatments of N-(2-methoxybenzoyl)-4-[(methylaminocarbonyl)amino]benzenesulfonamide, Cloqunitocet-mexyl, and Isoxadifen each at 100 gai/ha at a water volume of 220 L/ha using a track sprayer. Untreated non-innoculated and inoculated control treatments were included.

One day after application of Group A and B treatments, spring wheat plants were inoculated with a spray suspension of F. graminearum spores at 2.5×10⁴ spores/mL. Group A and B spring wheat plants where then incubated at 22° C. for 3 days in the dark at 100% Relative Humidity (RH), followed by 6 days at 65% R.H. at 12 hour light/dark intervals at 22° C.

Percent Fusarium Head Blight control (% FHB Control) and Deoxynivalenol (DON) content within harvested grain was assessed ten days after Fusarium graminearum inoculation. The results for applications of safeners alone for Group A treatments (GS 59) are summarized in Table 1.

TABLE 1
Efficacy of safeners alone on FHB control and DON reduction
for Group A treatments at Growth Stage 59 on spring wheat.

| | % FHB | % DON |
|---|---|---|
| Treatment | Control* | Reduction |
| N-(2-methoxybenzoyl)-4- | 7 | 0 |
| [(methylaminocarbonyl)amino] | | |
| benzenesulfonamide (100 gai/ha) | | |
| Cloqunitocet (100 gai/ha) | 1 | 9 |
| Isoxadifen (100 gai/ha) | 0 | 17 |

*% FHB Control and % DON Reduction relative to inoculated untreated check.

Percent Fusarium Head Blight infection values after Fusarium graminearum inoculation within harvested spring wheat grain for Group B treatments (GS 65/69) after applications of Isoxadifen applied alone (100 gai/ha) and in combination with Prothioconazole (at 50, 100, 200 gai/ha) and 3-difluoromethyl-1-methyl-1H-pyrazole-4-carboxylic acid methoxy-[1-methyl-2-(2,4,6-trichlorophenyl)-ethyl]-amide (at 50, 100, 200 gai/ha) safeners alone at GS 65/69 is summarized in Table 2.

TABLE 2
Efficacy of safener (Isoxadifen) in combination with fungicides on FHB control for Group
B treatments at Growth Stage 65/69 on spring wheat.

| | | FHB Area | Observed | Expected* | % Efficacy | |
|---|---|---|---|---|---|---|
| | FHB | (% of | % FHB | % FHB | Observed − | Synergy |
| Treatment | Area | Control) | Efficacy | Efficacy | Expected | Value** |
| Control, innoculated | 60.7 | | | | | |
| Isoxadifen (100 | 81.3 | 133.9 | 0.0 | | | |
| gai/ha) | | | | | | |
| Prothioconazole (50 | 28.1 | 46.3 | 53.7 | | | |
| gai/ha) | | | | | | |
| Prothioconazole | 57.5 | 94.7 | 5.3 | | | |
| (100 gai/ha) | | | | | | |
| Prothioconazole | 7.3 | 12.0 | 88.0 | | | |
| (200 gai/ha) | | | | | | |
| 3-difluoromethyl-1- | 8.3 | 13.7 | 86.3 | | | |
| methyl-1H-pyrazole- | | | | | | |
| 4-carboxylic acid | | | | | | |
| methoxy-[1-methyl- | | | | | | |
| 2-(2,4,6- | | | | | | |
| trichlorophenyl)- | | | | | | |
| ethyl]-amide | | | | | | |
| (50 gai/ha) | | | | | | |
| 3-difluoromethyl-1- | 7.5 | 12.4 | 87.6 | | | |
| methyl-1H-pyrazole- | | | | | | |
| 4-carboxylic acid | | | | | | |
| methoxy-[1-methyl- | | | | | | |
| 2-(2,4,6- | | | | | | |
| trichlorophenyl)- | | | | | | |
| ethyl]-amide | | | | | | |
| (100 gai/ha) | | | | | | |
| 3-difluoromethyl-1- | 7 | 11.5 | 88.5 | | | |
| methyl-1H-pyrazole- | | | | | | |
| 4-carboxylic acid | | | | | | |
| methoxy-[1-methyl- | | | | | | |
| 2-(2,4,6- | | | | | | |
| trichlorophenyl)- | | | | | | |
| ethyl]-amide | | | | | | |
| (200 gai/ha) | | | | | | |
| Isoxadifen + | 22.7 | 37.4 | 62.6 | 53.7 | 8.9 | 1.17 |
| Prothioconazole | | | | | | |
| (100 gai/ha + 50 | | | | | | |
| gai/ha) | | | | | | |
| Isoxadifen + | 8.6 | 14.2 | 85.8 | 5.3 | 80.6 | 16.28 |
| Prothioconazole | | | | | | |
| (100 gai/ha + 100 | | | | | | |
| gai/ha) | | | | | | |
| Isoxadifen + | 4.7 | 7.7 | 92.3 | 88.0 | 4.3 | 1.05 |
| Prothioconazole | | | | | | |
| (100 gai/ha + 200 | | | | | | |
| gai/ha) | | | | | | |
| Isoxadifen + | 7.7 | 12.7 | 87.3 | 86.3 | 1.0 | 1.01 |
| 3-difluoromethyl-1- | | | | | | |
| methyl-1H-pyrazole- | | | | | | |
| 4-carboxylic acid | | | | | | |
| methoxy-[1-methyl- | | | | | | |
| 2-(2,4,6- | | | | | | |
| trichlorophenyl)- | | | | | | |
| ethyl]-amide | | | | | | |
| (100 gai/ha + 50 | | | | | | |
| gai/ha) | | | | | | |
| Isoxadifen + | 16.5 | 27.2 | 72.8 | 87.6 | −14.8 | 0.83 |
| 3-difluoromethyl-1- | | | | | | |
| methyl-1H-pyrazole- | | | | | | |
| 4-carboxylic acid | | | | | | |
| methoxy-[1-methyl- | | | | | | |
| 2-(2,4,6- | | | | | | |
| trichlorophenyl)- | | | | | | |
| ethyl]-amide | | | | | | |
| (100 gai/ha + 100 | | | | | | |
| gai/ha) | | | | | | |
| Isoxadifen + | 8.5 | 14.0 | 86.0 | 88.5 | −2.5 | 0.97 |
| 3-difluoromethyl-1- | | | | | | |
| methyl-1H-pyrazole- | | | | | | |
| 4-carboxylic acid | | | | | | |
| methoxy-[1-methyl- | | | | | | |
| 2-(2,4,6- | | | | | | |
| trichlorophenyl)- | | | | | | |
| ethyl]-amide | | | | | | |
| (100 gai/ha + 200 | | | | | | |
| gai/ha) | | | | | | |

*Expected FHB efficacy levels described by Colby Equation (below) where X = % FHB Control level from safener treatment alone (e.g., Isoxadifen at 100 gai/ha) and Y = % FHB Control from fungicide treatment alone (e.g., Prothioconazole at 200 gai/ha).
$E = X + Y - \frac{X \cdot Y}{100}$ **Synergy Factor, given by Observed % FHB Efficacy ÷ Expected* % FHB Efficacy. Value > “1”.

Deoxynivalenol levels (DON, ppm) after Fusarium graminearum inoculation within harvested spring wheat grain for Group B treatments (GS 65/69) after applications of Isoxadifen applied alone (100 gai/ha) and in combination with Prothioconazole (at 50, 100, 200 gai/ha) and 3-difluoromethyl-1-methyl-1H-pyrazole-4-carboxylic acid methoxy-[1-methyl-2-(2,4,6-trichlorophenyl)-ethyl]-amide (at 50, 100, 200 gai/ha) safeners alone at GS 65/69 is summarized in Table 3.

TABLE 3
Efficacy of safeners alone on reduction of DON levels for Group B treatments at Growth
Stage 65/69 on spring wheat.

| | DON | DON | Observed | Expected* | % Efficacy | |
|---|---|---|---|---|---|---|
| | Levels | Levels (% | % DON | % DON | Observed − | Synergy |
| Treatment | (ppm) | of Control) | Efficacy | Efficacy | Expected | Value** |
| Control, innoculated | 27.306 | | | | | |
| Isoxadifen (100 | 29.098 | 106.6 | 0.0 | | | |
| gai/ha) | | | | | | |
| Prothioconazole (50 | 10.274 | 37.6 | 62.4 | | | |
| gai/ha) | | | | | | |
| Prothioconazole (100 | 10.456 | 38.3 | 61.7 | | | |
| gai/ha) | | | | | | |
| Prothioconazole (200 | 4.322 | 15.8 | 84.2 | | | |
| gai/ha) | | | | | | |
| 3-difluoromethyl-1- | 7.084 | 25.9 | 74.1 | | | |
| methyl-1H-pyrazole- | | | | | | |
| 4-carboxylic acid | | | | | | |
| methoxy-[1-methyl-2- | | | | | | |
| (2,4,6- | | | | | | |
| trichlorophenyl)- | | | | | | |
| ethyl]-amide | | | | | | |
| (50 gai/ha) | | | | | | |
| 3-difluoromethyl-1- | 4.388 | 16.1 | 83.9 | | | |
| methyl-1H-pyrazole- | | | | | | |
| 4-carboxylic acid | | | | | | |
| methoxy-[1-methyl-2- | | | | | | |
| (2,4,6- | | | | | | |
| trichlorophenyl)- | | | | | | |
| ethyl]-amide | | | | | | |
| (100 gai/ha) | | | | | | |
| 3-difluoromethyl-1- | 3.187 | 11.7 | 88.3 | | | |
| methyl-1H-pyrazole- | | | | | | |
| 4-carboxylic acid | | | | | | |
| methoxy-[1-methyl-2- | | | | | | |
| (2,4,6- | | | | | | |
| trichlorophenyl)- | | | | | | |
| ethyl]-amide | | | | | | |
| (200 gai/ha) | | | | | | |
| Isoxadifen + | 8.954 | 32.8 | 67.2 | 62.4 | 4.8 | 1.08 |
| Prothioconazole | | | | | | |
| (100 gai/ha + 50 | | | | | | |
| gai/ha) | | | | | | |
| Isoxadifen + | 4.684 | 17.2 | 82.8 | 61.7 | 21.1 | 1.34 |
| Prothioconazole | | | | | | |
| (100 gai/ha + 100 | | | | | | |
| gai/ha) | | | | | | |
| Isoxadifen + | 2.773 | 10.2 | 89.8 | 84.2 | 5.7 | 1.07 |
| Prothioconazole | | | | | | |
| (100 gai/ha + 200 | | | | | | |
| gai/ha) | | | | | | |
| Isoxadifen + | 3.113 | 11.4 | 88.6 | 74.1 | 14.5 | 1.20 |
| 3-difluoromethyl-1- | | | | | | |
| methyl-1H-pyrazole- | | | | | | |
| 4-carboxylic acid | | | | | | |
| methoxy-[1-methyl-2- | | | | | | |
| (2,4,6- | | | | | | |
| trichlorophenyl)- | | | | | | |
| ethyl]-amide | | | | | | |
| (100 gai/ha + 50 | | | | | | |
| gai/ha) | | | | | | |
| Isoxadifen + | 6.683 | 24.5 | 75.5 | 83.9 | −8.4 | 0.90 |
| 3-difluoromethyl-1- | | | | | | |
| methyl-1H-pyrazole- | | | | | | |
| 4-carboxylic acid | | | | | | |
| methoxy-[1-methyl-2- | | | | | | |
| (2,4,6- | | | | | | |
| trichlorophenyl)- | | | | | | |
| ethyl]-amide | | | | | | |
| (100 gai/ha + 100 | | | | | | |
| gai/ha) | | | | | | |
| Isoxadifen + | 2.973 | 10.9 | 89.1 | 88.3 | 0.8 | 1.01 |
| 3-difluoromethyl-1- | | | | | | |
| methyl-1H-pyrazole- | | | | | | |
| 4-carboxylic acid | | | | | | |
| methoxy-[1-methyl-2- | | | | | | |
| (2,4,6- | | | | | | |
| trichlorophenyl)- | | | | | | |
| ethyl]-amide | | | | | | |
| (100 gai/ha + 200 | | | | | | |
| gai/ha) | | | | | | |

*Expected FHB efficacy levels described by Colby Equation (below) where X = % FHB Control level from safener treatment alone (e.g., Isoxadifen at 100 gai/ha) and Y = % FHB Control from fungicide treatment alone (e.g., Prothioconazole at 200 gai/ha).
$E = X + Y - \frac{X \cdot Y}{100}$ **Synergy Factor, given by Observed % FHB Efficacy ÷ Expected* % FHB Efficacy. Value > “1”.

### Example 2

Corn seeds of the Garst hybrid 86C73-3000GT were planted and grown in the greenhouse at 22° C., 12 hours of light/12 hours of dark using an experiment based on a randomized complete block (RCB) design with ten replicates.

Safeners tested were: N-(2-methoxybenzoyl)-4-[(methylaminocarbonyl)amino]benzenesulfonamide, Cyprosulfamide, and Isoxadifen, alone and in combination with Prothioconazole fungicide, were applied at the beginning of tasselling stage (GS 51-55) at rates of 100 gai/ha. Prothioconazole was tested alone at rates of 50, 100, and 200 gai/ha. Prothioconazole was tested in combination with safeners at 100 gai/ha. An additional treatment of Prothioconazole at 50 gai/ha+Isoxadifen at 100 gai/ha was included. All treatments were applied a water volume of 220 L/ha using a track sprayer. The adjuvant X-77 was included in each treatment of maize at a rate of 0.125% v/v. Untreated non-innoculated and inoculated control treatments were included within the treatment list.

Maize was inoculated with Fusarium verticillioides at flowering/silking stage (GS 61-65) by spraying conidia of F. verticillioides on the emerged silk at 1.0×10⁶ conidia/mL. Treated plants where then incubated in the dark at 22° C. for 3 days in the dark at 100% R.H., followed by 6 days at 65% R.H. at 12 hour light/dark intervals at 22° C.

Maize was harvested at maturity, the weight of corn seeds per ear was recorded. Fusarium disease severity per maize ear was determined by plating a ten seeds per ear on Fusarium selective agar media. Seeds were surface sterilized with 5% sodium hypochloride for 1 minute followed by washing with sterile water for 1 minute, prior to plating on selective media. After plating, seeds were incubated in the dark at 15° C. for 10 days.

Fusarium verticilliodes disease severity per maize ear for treated and untreated control maize plants as summarized in Table 4 demonstrates that applications of safeners alone and in combination with prothioconazole reduced disease severity. Although applications of prothioconazole alone reduced disease severity, a dose-response to fungicide treatment was inconclusive. Applications of safeners alone (i.e., N-(2-methoxybenzoyl)-4-[(methylaminocarbonyl)amino]benzenesulfonamide Cyprosulfamide; and Isoxadifen) at 100 gai/ha resulted in greatly reduced F. verticilliodes disease severity.

TABLE 4
Fusarium verticillioides disease severity per maize ear.

| | % Disease Severity | | Fusarium Efficacy | | | |
|---|---|---|---|---|---|---|
| | Observed | % of | Observed | Expected* | Obs. − | Synergy |
| Treatment^{†} | per Ear | Control | (%) | % | Expc. | Value** |
| Control, non- | 0.35 | | | | | |
| innoculated | | | | | | |
| Control, innoculated | 14.2 | | | | | |
| Prothioconazole (50 | 7.5 | 51.6 | 48.4 | | | |
| gai/ha) | | | | | | |
| Prothioconazole | 12.6 | 88.4 | 11.6 | | | |
| (100 gai/ha) | | | | | | |
| Prothioconazole | 10.7 | 74.7 | 25.3 | | | |
| (200 gai/ha) | | | | | | |
| N-(2- | 9.9 | 69.0 | 31.0 | | | |
| methoxybenzoyl)-4- | | | | | | |
| [(methylaminocarbonyl) | | | | | | |
| amino]benzene | | | | | | |
| sulfonamide | | | | | | |
| (100 gai/ha) | | | | | | |
| Cyprosulfamide | 5.9 | 40.1 | 59.9 | | | |
| (100 gai/ha) | | | | | | |
| Isoxadifen (100 | 6.2 | 42.2 | 57.8 | | | |
| gai/ha) | | | | | | |
| N-(2- | 9.1 | 63.2 | 36.8 | 39.0 | −2.2 | 0.94 |
| methoxybenzoyl)-4- | | | | | | |
| [(methylaminocarbonyl) | | | | | | |
| amino]benzene | | | | | | |
| sulfonamide + | | | | | | |
| Prothioconazole | | | | | | |
| (100 gai/ha + 100 | | | | | | |
| gai/ha) | | | | | | |
| Cyprosulfamide + | 5.0 | 33.3 | 66.7 | 64.6 | 2.2 | 1.03 |
| Prothioconazole | | | | | | |
| (100 gai/ha + 100 | | | | | | |
| gai/ha) | | | | | | |
| Isoxadifen + | 9.9 | 69.0 | 31.0 | 78.2 | −47.1 | 0.40 |
| Prothioconazole | | | | | | |
| (100 gai/ha + 50 | | | | | | |
| gai/ha) | | | | | | |
| Isoxadifen + | 7.9 | 54.5 | 45.5 | 62.6 | −17.2 | 0.73 |
| Prothioconazole | | | | | | |
| (100 gai/ha + 100 | | | | | | |
| gai/ha) | | | | | | |

^{†}All treatments applied with X-77 adjuvant at a rate of 0.125% v/v
*Expected FHB efficacy levels described by Colby Equation (below) where X = % FHB Control level from safener treatment alone (e.g., Isoxadifen at 100 gai/ha) and Y = % FHB Control from fungicide treatment alone (e.g., Prothioconazole at 100 gai/ha).
$E = X + Y - \frac{X \cdot Y}{100}$ **Synergy Factor, given by Observed % FHB Efficacy ÷ Expected* % FHB Efficacy. Value > “1”.

### Example 3

Corn seeds of the Garst hybrid 86C73-3000GT were planted and grown in the greenhouse at 22° C., 12 hours of light/12 hours of dark using an experiment based on a randomized complete block (RCB) design with eleven replicates.

Safeners tested were Cyprosulfamide, Cloquintocet and N-(2-methoxybenzoyl)-4-[(methylaminocarbonyl)amino]benzenesulfonamide, alone and in combination with Prothioconazole fungicide, were applied at the beginning of tasselling stage (GS 51-55) at rates of 100 gai/ha. All treatments were applied a water volume of 220 L/ha using a track sprayer. The adjuvant X-77 was included in each treatment of maize at a rate of 0.125% v/v. Untreated non-innoculated and inoculated control treatments were included within the treatment list.

Maize was inoculated with Fusarium verticillioides and Fusarium graminearium at flowering/silking stage (GS 61-65) by spraying conidia on the emerged silk at 1.0×10⁶ conidia/mL (F. verticillioides) and at 1.0×10⁴ conidia/mL (F. graminearium). Treated plants where then incubated in the dark at 22° C. for 3 days in the dark at 100% R.H., followed by 6 days at 65% R.H. at 12 hour light/dark intervals at 22° C.

Maize was harvested at maturity, the weight of corn seeds per ear was recorded. Maize grain weight per maize ear (grams/ear) as summarized in Table 5 demonstrates that applications of safeners alone and in combination with prothioconazole increased maize grain weight per ear relative to Fusarium-inoculated check

TABLE 5
Efficacy of safeners alone and in combination with prothioconazole on average maize
grain weight per maize ear.

| | Effect on Maize Weight per maize Ear | | | |
|---|---|---|---|---|
| | Observed Mass | Expected Mass * | | |
| Treatment^{†} | (grams) | (grams) | Obs. − Expc. | Synergy Value** |
| Control, non- | 108.7 | | | |
| innoculated | | | | |
| Control, innoculated | 101.6 | | | |
| Prothioconazole | 104.0 | | | |
| (100 gai/ha) | | | | |
| Prothioconazole | 107.8 | | | |
| (200 gai/ha) | | | | |
| N-(2- | 105.3 | | | |
| methoxybenzoyl)-4- | | | | |
| [(methylaminocarbonyl) | | | | |
| amino]benzene | | | | |
| sulfonamide | | | | |
| (100 gai/ha) | | | | |
| Cyprosulfamide | 104.4 | | | |
| (100 gai/ha) | | | | |
| Cloquintocet (100 | 103.5 | | | |
| gai/ha) | | | | |
| N-(2- | 108.8 | 99.8 | +9.0 | 1.09 |
| methoxybenzoyl)-4- | | | | |
| [(methylaminocarbonyl) | | | | |
| amino]benzene | | | | |
| sulfonamide + | | | | |
| Prothioconazole | | | | |
| (100 gai/ha + 100 | | | | |
| gai/ha) | | | | |
| Cyprosulfamide + | 108.6 | 99.8 | +8.8 | 1.09 |
| Prothioconazole | | | | |
| (100 gai/ha + 100 | | | | |
| gai/ha) | | | | |
| Cloquintocet + | 105.9 | 99.9 | +6.0 | 1.06 |
| Prothioconazole | | | | |
| (100 gai/ha + 50 | | | | |
| gai/ha) | | | | |

^{†}All treatments applied with X-77 adjuvant at a rate of 0.125% v/v
* Expected maize grain weight values described by Colby Equation (below) where X = Maize Grain Weight per Maize Ear from safener treatment alone (e.g., Cyprosulfamide at 100 gai/ha) and Y = % Maize Grain Weight per Maize Ear from fungicide treatment alone (e.g., Prothioconazole at 100 gai/ha).
$E = X + Y - \frac{X \cdot Y}{100}$ ** Synergy Factor, given by Observed % FHB Efficacy ÷ Expected* % FHB Efficacy. Value > “1”.

1. A method of treating accumulation of mycotoxins and/or secondary fungal metabolites on a plant or harvested plant material, said method comprising applying one or more herbicide safeners to the plant in the absence of a co-applied herbicide.

2. The method according to claim 1, wherein said herbicide safener is selected from Daimuron, Cumyluron, Dimepiperate, Cloquintocet-methyl, Fenchlorazole-ethyl, Mefenpyr-diethyl, Isoxadifen-ethyl, Cyprosulfamide, or N-(2-methoxybenzoyl)-4-[(methylaminocarbonyl)amino]-benzenesulfonamide.

3. The method according to claim 1, wherein said mycotoxin accumulation is caused by fungi.

4. The method according to claim 2, wherein said fungi comprises one or more species of Fusarium, Myrothecium, Trichoderma, Trichothecium, Cephalosporium, Verticimonosporium, Gibberella, Aspergillus, Claviceps, Paecilomyces, Alternaria, Stachybotrys, and Penicillium.

5. The method according to claim 3, wherein said mycotoxin comprises one or more of a Aflatoxins, Beauvericin, Citrinin, Cytochalasins, Enniatins, Ergot alkaloids, Fumonisins, Fusaproliferin, Fusaric Acid, Fusarins, Gilotoxin, Moniliformin, Ochratoxins, Patulin, Sterigmatocystin, Trichothecenes, Zeranol, Zearalenones, or a secondary fungal metabolite such as Cyclopiazonic acid.

6. The method according to claim 5, further comprising applying one or more chemical fungicides to the plant.

7. The method according to claim 6, wherein said fungicide is prothioconazole or 3-difluoromethyl-1-methyl-1H-pyrazole-4-carboxylic-acid-methoxy-[1-methyl-2-(2,4,6-trichlorophenyl)-ethyl]-amide.

8. The method according to claim 7, wherein the herbicide safener is N-(2-methoxybenzoyl)-4-[(methylaminocarbonyl)amino]benzenesulfonamide, cloquintocet-methyl, isoxadifen-ethyl or cyprosulfamide.

9. The method according to claim 8, wherein the plant is selected from cereals comprising wheat, barley, rye, oats maize, rice, sorghum, and corn; leguminous plants comprising beans, lentils, peas, soybeans, peanuts and tree nuts; oil plants comprising rape, mustard, and sunflowers; cucumber plants comprising marrows, cucumbers, and melons; and, vegetables comprising spinach, lettuce, asparagus, cabbages, carrots, eggplants, onions, pepper, tomatoes, potatoes, and paprika.

10. The method according to claim 9, wherein said plant is a cereal.

11. The method according to claim 10, wherein said cereal is wheat or corn.

12. The method according to claim 11, wherein said wheat is treated at a growth stage of about GS 39 to about GS 79.

13. The method according to claim 12, wherein said wheat is treated at a growth stage of about GS 59 to about GS 69.

14. The method according to claim 11, wherein said corn is treated at a growth stage after GS 39 to about GS 79.

15. The method according to claim 14, wherein said corn is treated at a growth stage of about GS 51 to about GS 79.

16. The method according to claim 1, wherein said safener is applied to the plant at 50-200 g/ha.

17. The method according to claim 6, wherein said fungicide and safener are each independently applied to the plant material at 50-200 g/ha.

18. The method according to claim 6, wherein the ratio by weight of the fungicide to the safener is 3:1 to 1:3.

19. The method according to claim 6, wherein said plant is further treated with insecticides, bactericides, nematicides, molluscicides, bird repellents, growth regulators, biological agents, fertilizers, micronutrient donors or other preparations that influence plant growth, such as inoculants, or mixtures thereof.

20. A plant treated with one or more herbicide safeners in the absence of a co-applied herbicide.

21. The plant of claim 20 further treated with one or more chemical fungicides.

22. A method of reducing infection of mycotoxin-producing pathogens on a plant or harvested plant material, said method comprising applying to the plant one or more herbicide safeners in the absence of a co-applied herbicide

23. The method of claim 22, where is said treatment further comprises applying one or more fungicides.

24. A method of reducing disease related a to mycotoxin-producing pathogen on a plant or harvested plant material, said method comprising applying to the plant one or more herbicide safeners in the absence of a co-applied herbicide

25. The method of claim 24, where is said treatment further comprises applying one or more fungicides.

26. The method of claim 24, wherein the disease is Fusarium Head Blight disease.

27. A system for determining the need of a plant for application of one or more herbicide safeners to reduce accumulation of mycotoxin and secondary and fungal metabolites on a plant or harvested plant material, said system comprises:
a. defining a maximum threshold amount of mycotoxin accumulation permissible on the plant or harvested plant material;
b. obtaining a sample from the plant or harvested plant material and determining the amount of mycotoxin accumulation;
c. comparing the mycotoxin accumulation amount in the sample against the threshold amount;
d. applying one or more herbicide safeners to the plant where the mycotoxin accumulation amount exceeds the threshold amount.

28. A method of controlling fungal pathogenesis, said method comprising applying one or more herbicide safeners to a plant in the absence of a co-applied herbicide.

29. An agrochemical composition for the treatment of a plant or harvested plant material, said composition comprising one or more herbicide safeners and one or more fungicides.

30. The composition of claim 29, wherein said herbicide safener is selected from Daimuron, Cumyluron, Dimepiperate, Cloquintocet-methyl, Fenchlorazole-ethyl, Mefenpyr-diethyl, Isoxadifen-ethyl, Cyprosulfamide, or N-(2-methoxybenzoyl)-4-[(methylaminocarbonyl)amino]-benzenesulfonamide and wherein said fungicide is prothioconazole or 3-difluoromethyl-1-methyl-1H-pyrazole-4-carboxylic acid methoxy-[1-methyl-2-(2,4,6-trichlorophenyl)-ethyl]-amide.
